(19) United States
(12) Patent Application Publication
(10) Pub. No.: US 2006/0224717 A1
(43) Pub. Date: Oct. 5, 2006

(54) Management system for warranting consistency between inter-client communication logs

(76) Inventors: Yuko Sawai, Kawasaki (JP); Kazuyoshi Hoshino, Tokyo (JP); Osamu Takata, Tokyo (JP); Tadashi Kaji, Yokohama (JP); Kohei Sawada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/391,349

(22) Filed: Mar. 29, 2006

(30) Foreign Application Priority Data
Mar. 30, 2005 (JP) 2005-096705

(51) Int. Cl. G06F 15/173

(52) U.S. Cl. 709/223

(57) ABSTRACT

In inter-peer communication between an application server for providing service such as Voice over IP or contents distribution and a client using the service, the client or the application server notifies a log management server of a communication log by a log information process. The log management server verifies consistency of the notified communication log by a log compare process requested by the client or the application server. Because the log information process and the log compare process are executed periodically during inter-peer communication, the client and the application server can detect inconsistency of the communication log instantaneously and notify each other of the consistency of the communication log.

### BACKGROUND OF THE INVENTION

1. Field of the Invention

The present invention relates to a technique for collecting and safekeeping inter-client communication logs periodically. Particularly, the technique is most suitably applied to an accounting system or status management for communication data exchanged between clients connected in accordance with SIP (Session Initiation Protocol) which is provided for managing sessions of audio communication or streaming communication on a network.

2. Description of the Related Art

Session initial protocol (SIP) is a technique for controlling and managing communication sessions in inter-peer communication or inter-client communication such as Internet Protocol (IP) phones, television meetings, Internet messages, etc. Functions close to those of a public telephone network, such as notification of sender's numbers, call forwarding, etc. are provided to the Internet communication by SIP. A system based on SIP comprises user agents (UAs) as clients using SIP, and SIP servers. The UAs are categorized into two functional modules, that is, user agent clients (UACS) starting requests and user agent servers (UASs) sending responses to these requests.

When a UAC wants to cooperate with a UAS by using SIP to assert a session to start audio communication or streaming communication, the UAC and the UAS register position information in an SIP server. When the UAC wants to start audio communication or streaming communication, the UAC transmits a communication start request message to the UAS through the SIP server. Upon reception of the communication start request message, the UAS sends a communication start response message, as a response to the communication start request message, back to the UAC through the SIP server in the same manner as described above. When the UAC receives the communication start response message, the UAC and the UAS can communicate with each other by using an existing protocol for inter-peer communication without interposition of SIP. Also in the case of termination of the inter-peer communication between the UAC and the UAS, the UAC transmits a communication completion request message to the UAS through the SIP server. Upon reception of the communication completion request message, the UAS transmits a communication completion response message to the UAC through the SIP server in the same manner as in the case of start of communication.

As described above, sessions of inter-peer communication between the UAC and the UAS are controlled by data exchange between the UAC and the UAS through SIP. The SIP server can know the time for establishing each session and the time for cutting off the session in the inter-peer communication between the UAC and the UAS by acquiring and safekeeping the time stamps of SIP messages transmitted by the UAC and the UAS, so that the SIP server can manage the time of communication in accordance with each session in the established inter-peer communication between the UAC and the UAS.

On the other hand, a configuration in which communication logs are collected through gateways arranged on a network including clients is used as a way to manage the quantity of communication to perform accounting in accordance with the quantity of communication in telephone or streaming communication. Since each client is connected to the communication network through a gateway corresponding to the client, all communication logs can be collected and managed so that information concerned with the quantity of communication can be acquired.

Generally in a client-server model including a client and an application server for providing service, a method using the application server for collecting communication logs to perform centralized management of the communication logs as described in JP-A-2003-333094 or a method using a gateway arranged on a network including the application server for collecting and managing logs as described in JP-A-2005-4427 is used for management and accounting with respect to the quantity of communication.

The SIP server can know a session start time and a session end time on the basis of the time stamps of SIP messages transmitted by the UAC and the UAS when the SIP server manages a session in the inter-peer communication between the UAC and the UAS. After establishment of the session between the UAC and the UAS, the UAC and the UAS communicate with each other directly without interposition of the SIP server. For this reason, contents of communication exchanged in inter-peer communication cannot be managed though the start time and the end time in inter-peer communication between the UAC and the UAS can be managed. A service provider for providing contents distribution service or voice over IP (VoIP) service needs to calculate a fee in accordance with the quantity of communication and charge the fee for the service. For collection and management of the contents of communication and the quantity of communication in the service using SIP, a system corresponding to the collection and management needs to be formed separately.

For collection and management of the contents of communication and the quantity of communication, as described above, there is a method using a gateway through which a client communicates with a server, or a method of forming a system in a client-server model so that a service provider acquires logs. In the former configuration in which communication is performed through the gateway, all communication data are however exchanged between a service user and a service provider through the gateway. For this reason, a data analyzing process and a data storage and management process are required in addition to a communication packet transfer process, so that the load imposed on the server is heavy.

In the latter configuration in the client-server model, communication logs collected by the server are present on the system managed by the service provider. For this reason, the quantity of communication and the fee for communication calculated based on the communication logs depend on the reliability of the service provider. In the configuration, there is a risk that a dishonest service provider will falsify the communication logs to charge an unreasonable fee to the service user.

### SUMMARY OF THE INVENTION

In order to solve the foregoing problem, the present invention makes a proposal to provide a log management server for managing communication logs. When, for example, communication logs between two communication apparatuses are to be managed, the log management server collects the communication logs as communication information indicating contents of communication exchanged between the two communication apparatuses from the two communication apparatuses respectively. The log management server compares the collected communication logs with each other to thereby verify consistency between the communication logs.

### BRIEF DESCRIPTION OF THE DRAWINGS

FIG. 1 shows an embodiment of a network configuration according to the invention;

FIG. 2 shows an embodiment of a sequence of overall processing according to the invention;

FIG. 3 shows an embodiment of a system configuration of a client or an application server;

FIG. 4 shows an embodiment of a system configuration of a log management server;

FIG. 5 is an explanatory view showing a method for carrying out a log information process;

FIG. 6 is an explanatory view showing a method for carrying out a log compare process;

FIG. 7 is an explanatory view showing an example of a method for carrying out the log compare process between different domains;

FIG. 8 is an explanatory view showing an example of a method for carrying out the log information process and the log compare process;

FIG. 9 is an explanatory view showing an example of a method for carrying out the log information process and the log compare process between different domains;

FIG. 10 is a flow chart showing an example of a procedure in a log management control portion of the client or the application server;

FIG. 11 is a flow chart showing an example of a procedure in a log management control portion of the log management server;

FIG. 12 is a flow chart showing an example of a procedure of a log process in a communication information acquisition portion of the client or the application server;

FIG. 13 is a flow chart showing an example of a procedure of a verification process performed by a log compare portion of the log management server;

FIG. 14 shows an embodiment of a communication correspondence table;

FIG. 15 shows an embodiment of a log information table;

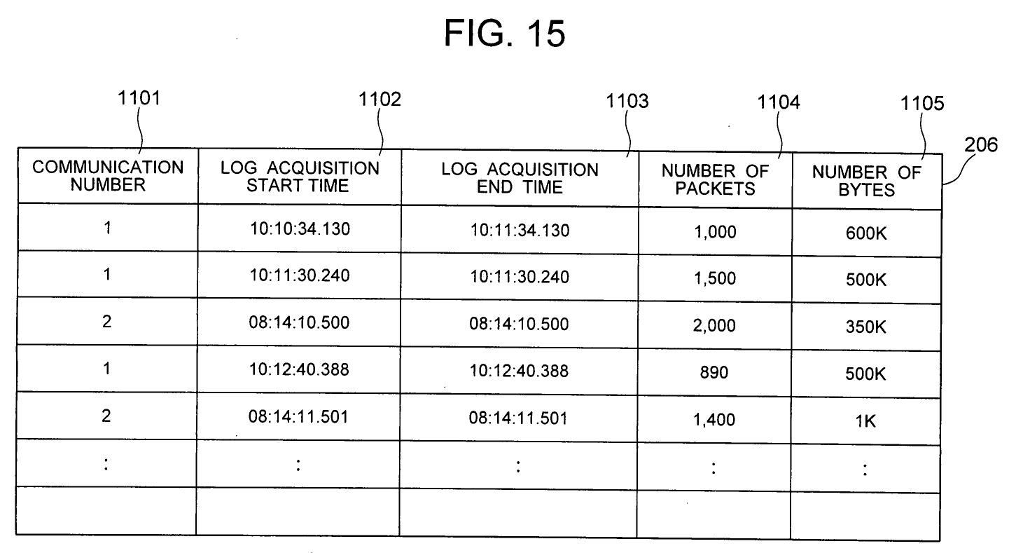

FIG. 16 shows an embodiment of a log management server correspondence table;

FIG. 17 shows an example of a data format of a log information message;

FIG. 18 shows an example of a data format of a log information acknowledgement message;

FIG. 19 shows an example of a data format of a log compare request message;

FIG. 20 shows an example of a data format of a log compare response message;

FIG. 21 shows an example of a data format of an inter-server log request message;

FIG. 22 shows an example of a data format of an inter-server log response message;

FIG. 23 shows an example of information exchanged among respective processing portions;

FIG. 24 shows an example of information exchanged in accordance with a data operation on the communication correspondence table;

FIG. 25 shows an example of information exchanged in accordance with a data operation on the log information table; and

FIG. 26 shows an example of information exchanged in accordance with a data operation on the log management server correspondence table.

### DETAILED DESCRIPTION OF THE INVENTION

The invention is effective in the case where accounting need be made in accordance with the quantity of communication used by a service user or in a mode in which reliability concerned with the quantity of communication between a service user and a service provider need be warranted in VoIP communication or contents distribution service using SIP for session management.

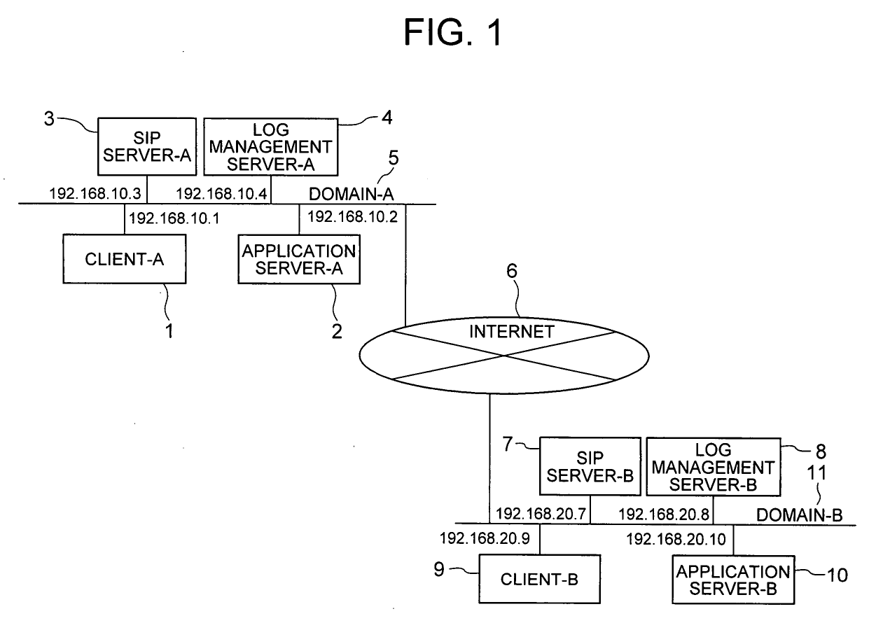

For example, as shown in FIG. 1, the invention is carried out in a mode in which one or more domains such as Domain-A (5) and Domain-B (11) are connected to the Internet 6 and at least one client such as Client-A (1) or Client-B (9) or at least one application server such as Application Server-A (2) or Application Server-B (10) belongs to each domain.

A system according to an embodiment of the invention comprises clients such as Client-A (1) and Client-B (9) using communication service, application servers such as Application Server-A (2) and Application Server-B (10) providing the service, SIP servers such as SIP Server-A (3) and SIP Server-B (7) performing session management of SIP communication, and log management servers such as Log Management Server-A (4) and Log Management Server-B (8) for managing communication logs. At least one SIP server such as SIP Server-A (3) or SIP Server-B (7) and at least one log management server such as Log Management Server-A (4) or Log Management Server-B (8) are provided in each domain. In each domain, the log management server such as Log Management Server-A (4) or Log Management Server-B (8) manages clients including Client-A (1) or Client-B (9) and Application Servers-A (2) or Application Server-B (10) belonging to the domain.

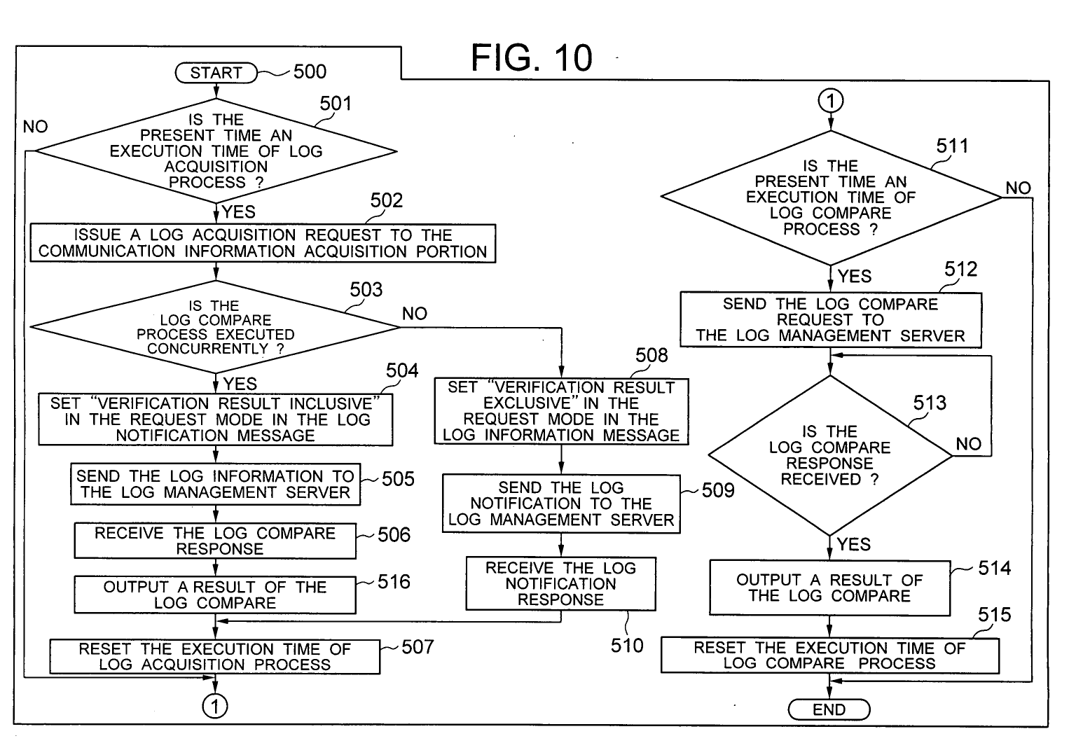

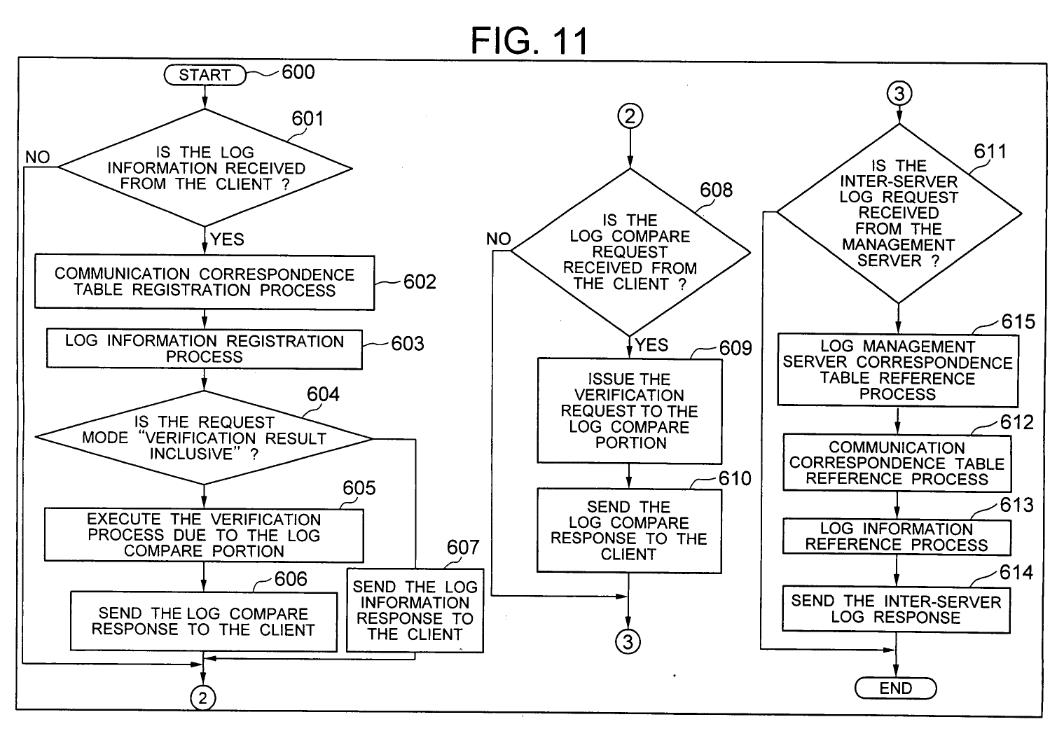

When a session of inter-peer communication is established between Client-A (1) (or Client-B (9)) and Application Server-A (2) (or Application Server-B (10)), communication information acquisition portions 201 in Client-A (1) (or Client-B (9)) and Application Server-A (2) (or Application Server-B (10)) acquire inter-peer communication information periodically. Log management control portions 200 in Client-A (1) (or Client-B (9)) and Application Server-A (2) (or Application Server-B (10)) start execution of Step 500 shown in a flow chart of FIG. 10. In Log Management Server-A (4) (or Log Management Server-B (8)), execution of Step 600 shown in a flow chart of FIG. 11 has been started in accordance with execution of programs according to an embodiment of the invention. These steps are repeated until a request to terminate these steps is given. Incidentally, the log management control portion 200 is equivalent to a “communication information management control portion” in the scope of the invention claimed at the time of application.

Embodiments of the invention will be described below on the assumption that Client-A (1) belonging to Domain-A communicates with Application Server-A (2) in an inter-peer communication manner. Incidentally, the same processing will be applied to the case where Client-B (2) communicates with Application Server-B (10) in an inter-peer communication manner.

Although communication using SIP will be described in the following embodiments, the invention can be also applied to communication using another protocol as will be described later. In this case, the term “session” designates a unit of communication performed between at least two communication apparatuses, for example, from the start to the end of transmission/reception of a series of data between two communication apparatuses.

### Embodiment 1

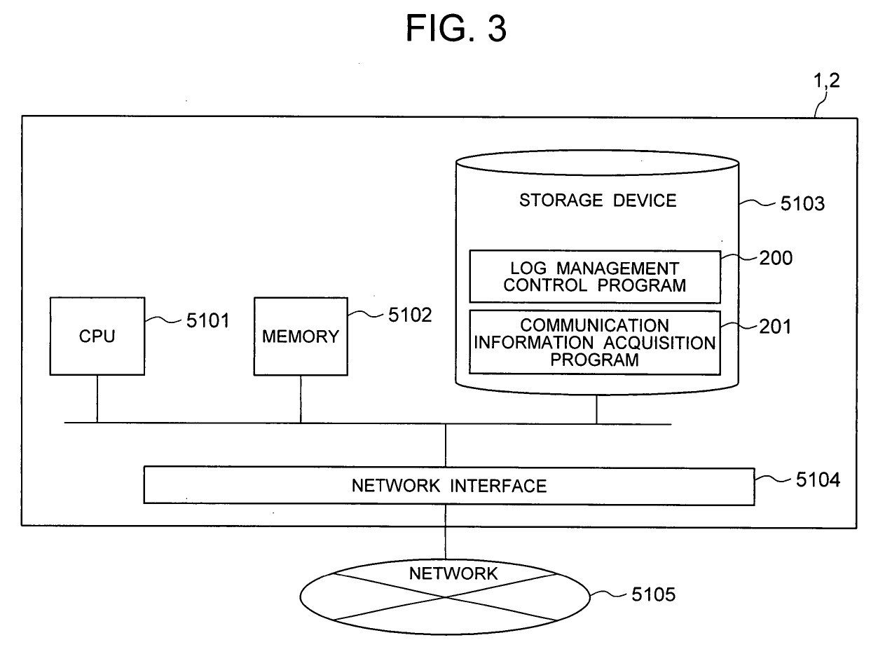

As shown in FIG. 3, each of Client-A (1) and Application Server-A (2) includes a CPU 5101, a memory 5102, a network interface 5104, and a storage device 5103. A communication information acquisition program 201 for acquisition of a communication log exchanged between Client-A (1) and Application Server-A (2) and a log management control program 200 for notifying Log Management Server-A (4) of the acquired log and requesting Log Management Server-A (4) to verify consistency of the acquired log are stored in the storage device 5103. The programs 201 and 200 are executed after expanded in the memory 5102.

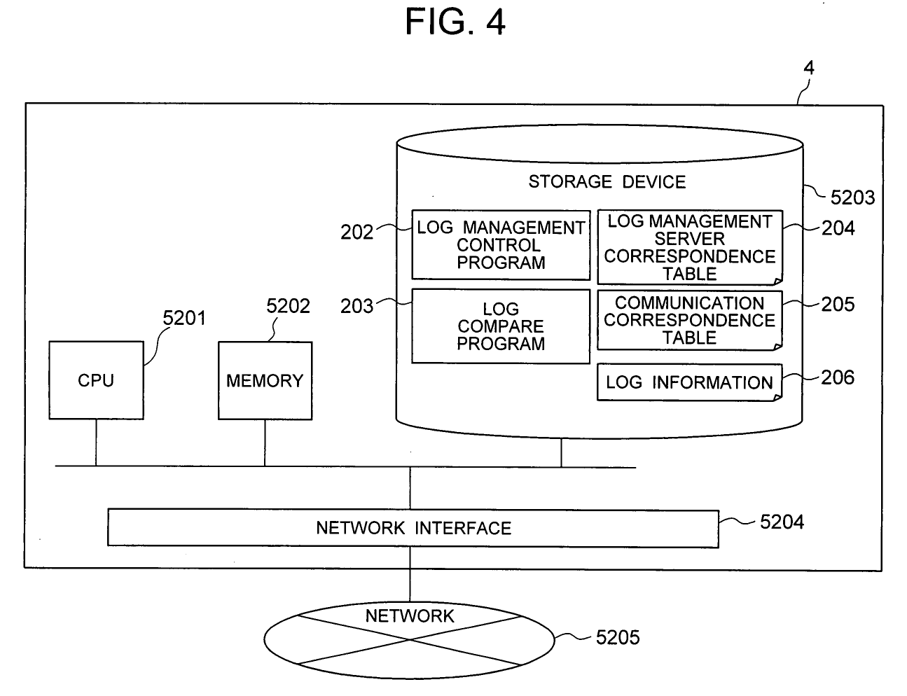

As shown in FIG. 4, Log Management Server-A (4) includes a CPU 5201, a memory 5202, and a storage device 5203. A log management control program 202 for receiving a log information request 101 transmitted from Client-A (1) or Application Server-A (2) and handing over a log compare request 103 transmitted from Client-A (1) or Application Server-A (2) to a log compare portion 203 of Log Management Server-A (4), and a log compare program 203 for verifying consistency of the log are stored in the storage device 5203. The programs 202 and 203 are executed after expanded in the memory 5202. Incidentally, the log compare portion 203 in this embodiment is equivalent to a “communication information verification portion” in the scope of the invention claimed at the time of application.

Log Management Server-A (4) further includes log information 206 for storing communication logs, a communication correspondence table 205 for registering and managing communication session information between Client-A (1) and Application Server-A (2), and a log management server correspondence table 204 for indicating Log Management Server-A (4) to which Client-A (1) and Application server-A (2) belong. Incidentally, the log information 206 in the embodiment is equivalent to a “communication information storage portion” in the scope of the invention claimed at the time of application. The log management server correspondence table 204 is equivalent to a “communication management apparatus correspondence storage portion” in the scope of the invention claimed at the time of application.

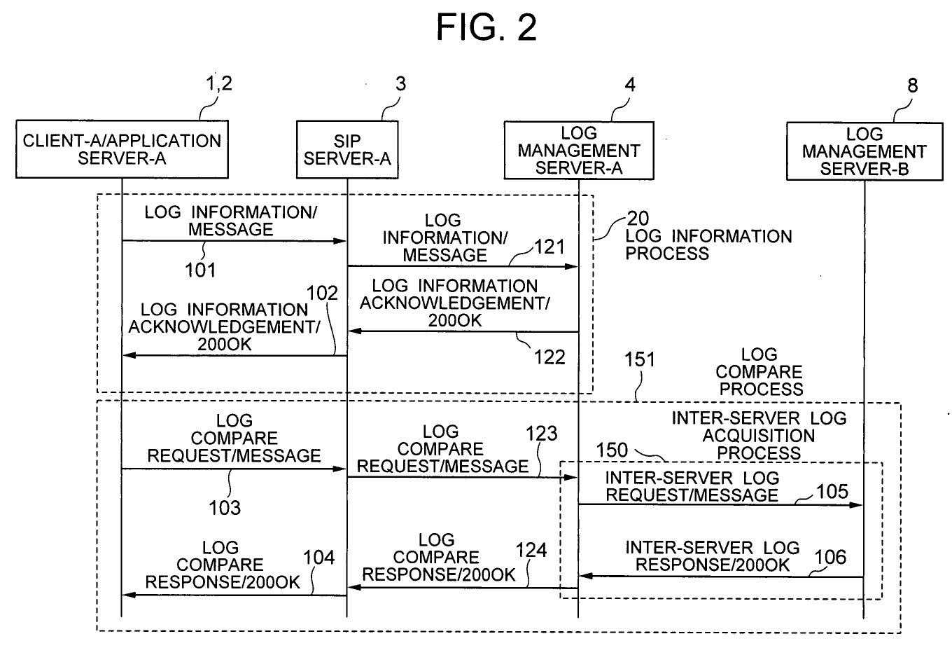

As shown in FIG. 2, a sequence for a log information process 20 and a log compare process 151 is provided in an embodiment of the invention. In the log information process 20, Client-A (1) or Application Server-A (2) notifies Log Management Server-A (4) of a log through a log information message 101 and transmits a log information message 121 to Log Management Server-A (4) via SIP Server-A (3). Upon reception of the log information message 121 from SIP Server-A (3), Log Management Server-A (4) stores the notified log on itself. Log Management Server-A (4) sends a log information acknowledgement 122 to Client-A (1) or Application Server-A (2) via SIP Server-A (3). Client-A (1) or Application Server-A (2) receives a log information acknowledgement 102 from SIP Server-A (3).

On the other hand, in the log compare process 151, Client-A (1) or Application Server-A (2) transmits a log compare request 103 to Log Management Server-A (4) via SIP Server-A (3). Upon reception of a log compare request 123 from SIP Server-A (3), Log Management Server-A (4) verifies consistency concerned with a designated range of the log. Log Management Server-A (4) transmits a result of the verification as a log compare response 124 to SIP Server-A (3). Upon reception of the log compare response 124, SIP Server-A (3) transfers the log compare response 124 as a log compare response 104 to Client-A (1) or Application Server-A (2). Upon reception of the log compare response 104, Client-A (1) or Application Server-A (2) can know consistency of the notified log.

Incidentally, when the client and the application server do not belong to one and the same domain, the log management server does not verify consistency of the communication log directly but executes an inter-server log acquisition process 150 shown in FIG. 2, in which the log management server acquires a communication log from a log management server in a domain to which a communication partner belongs.

In FIG. 1, when Client-A (1) belonging to Domain-A (5) intends to communicate with Application Server-B (10) belonging to Domain-B (11) in an inter-peer communication manner, Client-A (1) executes a log compare process 151. Upon reception of a log compare request 123, Log Management Server-A (4) transmits an inter-server log request 105 to Log Management Server-B (8) of Domain-B (11) to execute an inter-server log acquisition process 150. Upon reception of the inter-server log request 105, Log Management Server-B (8) transmits a communication log acquired from Application Server-B (10) in a log information process 20, as an inter-server log response 106 to Log Management Server-A (4).

With respect to the log information process 20 or the log compare process 151, a time interval for executing the process 20 or 151 periodically is determined in advance. Client-A (1) or Application Server-A (2) executes these processes whenever the predetermined time lapses. As shown in FIG. 2, the messages to be exchanged between Client-A (1) and SIP Server-A (3), between SIP Server-A (3) and Log Management Server-A (4) and between Log Management Server-A (4) and Application Server-A (2) use a sequence in a message method in SIP.

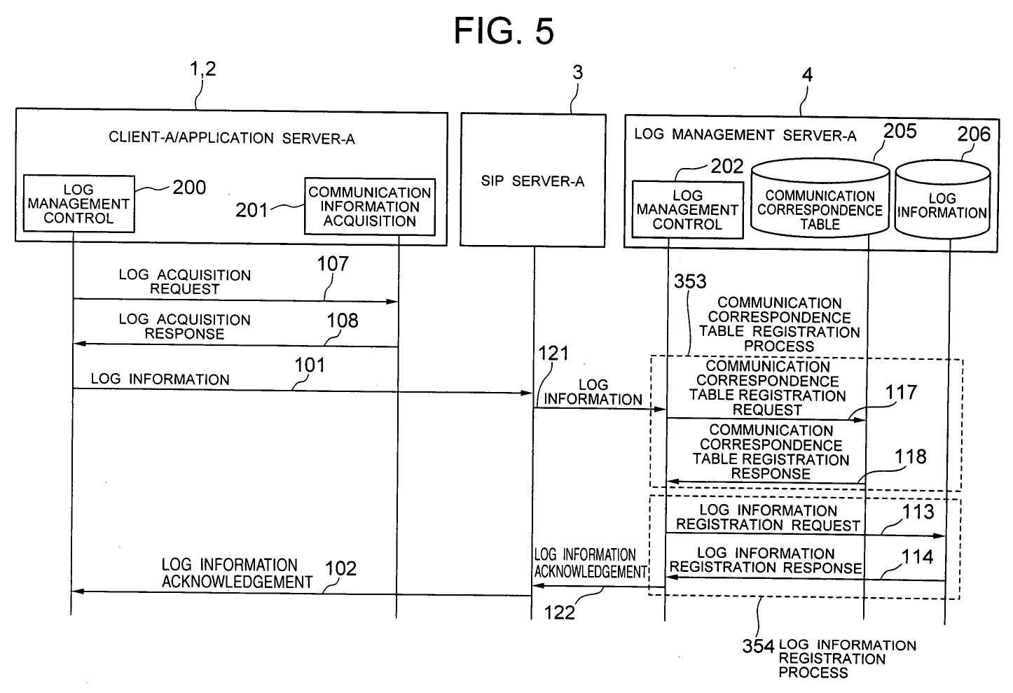

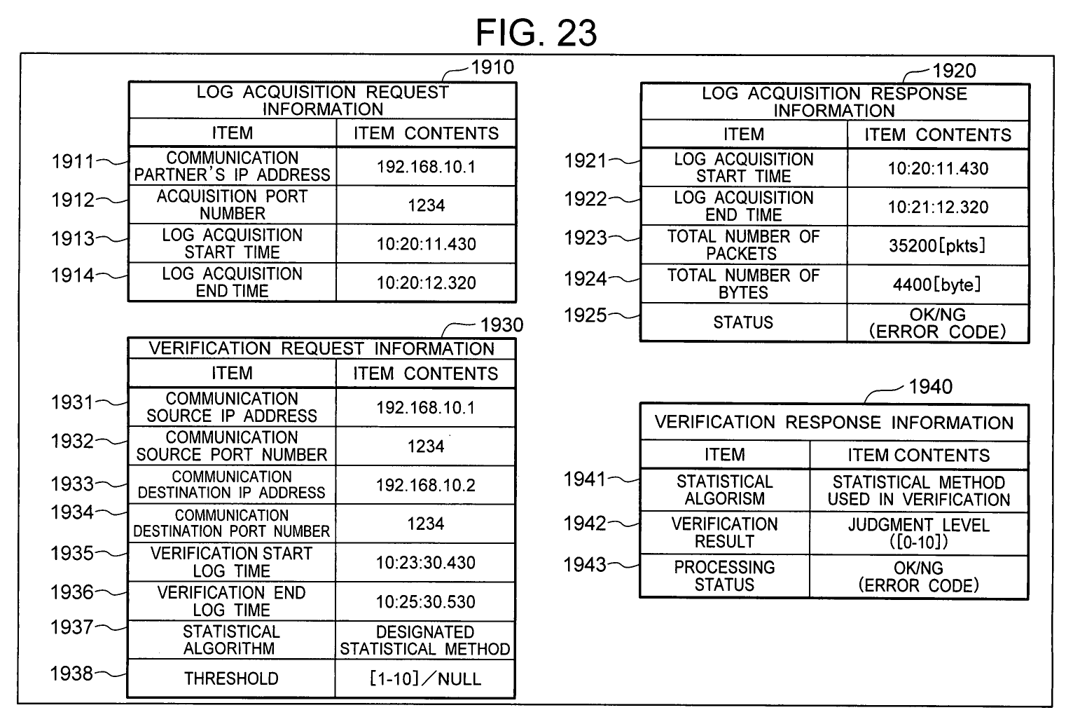

The log information process 20 in the embodiment will be described as follows. A sequence in the log information process 20 is shown in FIG. 5. The log management control portion 200 of Client-A (1) judges whether the present time is coincident with a predetermined execution time of the log information process 20 or not (step 501). When the present time is coincident with the predetermined execution time, the log management control portion 200 of Client-A (1) sends a log acquisition request 107 shown in FIG. 23 to the communication acquisition portion 201 of Client-A (1) (step 502).

The log acquisition request 107 contains the contents listed as log acquisition request information 1910 shown in FIG. 23. The log acquisition request information 1910 contains fields of a communication partner's IP address 1911, an acquisition port number 1912, a log acquisition start time 1913 and a log acquisition end time 1914. The log acquisition end time 1914 is a time obtained by adding a predetermined log acquisition time interval to the log acquisition start time 1913. In this embodiment, the IP address 192.168.10.2 of Application Server-A (2) is stored in the field of the communication partner's IP address 1911. A port number used in inter-peer communication between Client-A (1) and Application Server-A (2) is stored in the field of the acquisition port number 1912.

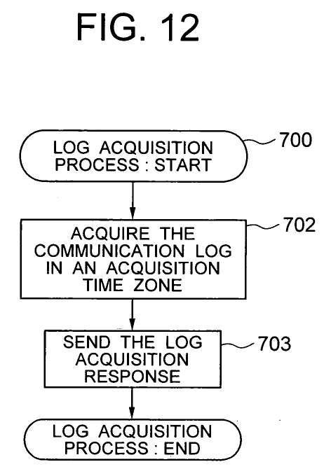

Upon reception the log acquisition request 107, the communication information acquisition portion 201 executes a log acquisition process shown in a flow chart of FIG. 12. In the log acquisition process (700), the communication information acquisition portion 201 acquires a communication log in a designated acquisition time period ranging from the log acquisition start time 1913 to the log acquisition end time 1914, from communication information acquired and stored in advance (step 702). The communication information acquired and stored in advance is information in which communication data passing through the network interface 5104 are recorded in the communication information acquisition portion 201 at intervals of a predetermined time after the start of inter-peer communication. Upon acquisition of the communication log (step 702), the communication information acquisition portion 201 sends a log acquisition response 108 back to the log management control portion 200 (step 703). The log acquisition response 108 contains log acquisition response information 1920 shown in FIG. 23. The log acquisition response information 1920 contains fields of a log acquisition start time 1921, a log acquisition end time 1922, a total number of packets 1923, a total number of bytes 1924 and a status 1925.

Upon reception of the log acquisition response 108, the log management control portion 200 transmits a log information 101 to SIP Server-A (3). Upon reception of the log information 101, SIP Server-A (3) transmits a log information 121 to Log Management Server-A (4) (step 509).

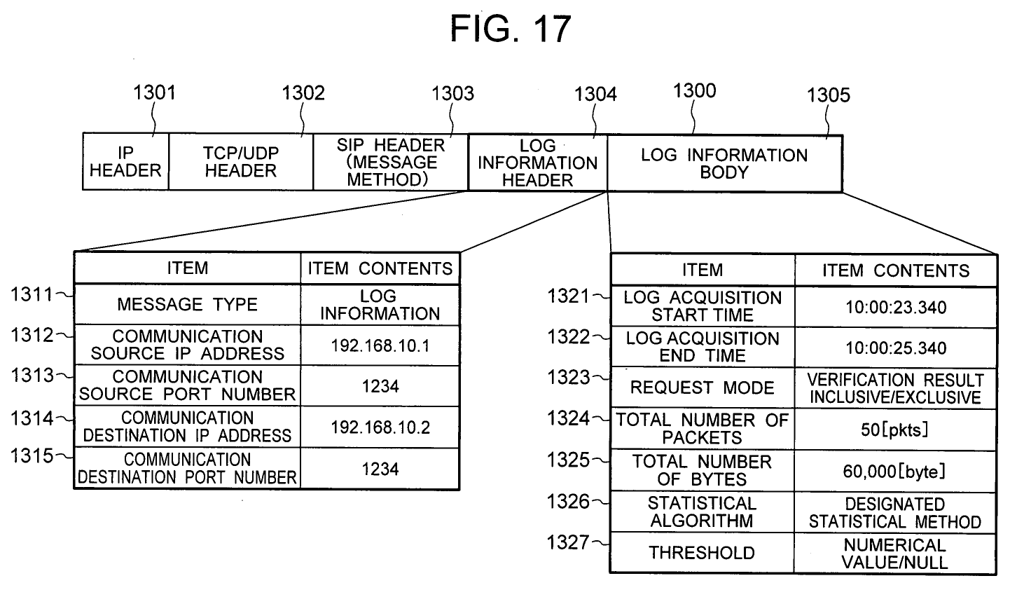

The log information 101 is provided as a log information message 1300 shown in FIG. 17 and stored in an SIP message of the message method. The log information message 1300 contains a log information header 1304, and a log information body 1305. The same information as that of the log information message 1300 in the log information 101 is stored in the log information 121 transmitted by SIP Server-A (3).

The log information header 1304 contains fields of a message type 1311, a communication source IP address 1312, a communication source port number 1313, a communication destination IP address 1314 and a communication destination port number 1315. Information indicating the log information message 1300 is set in the field of the message type 1311 in the log information header 1304. The IP address 192.168.10.1 of Client-A (1) transmitting the log information 101 is set in the field of the communication source IP address 1312 in the log information header 1304. A port number used for the inter-peer communication between Client-A (1) and Application Server-A (2) is set in the field of the communication source port number 1313 in the log information header 1304. The IP address 192.168.10.2 and port number of Application Server-A (2) are set in the fields of the communication destination IP address 1314 and the communication destination port number 1315 respectively in the log information header 1304.

The log information body 1305 contains fields of a log acquisition start time 1321, a log acquisition end time 1322, a request mode 1323, a total number of packets 1324, a total number of bytes 1325, a statistical algorithm 1326, and a threshold 1327. In the log information body 1305, the log acquisition start time 1321 and the log acquisition end time 1322 indicate a time zone in which the log was acquired. The number of packets in the communication log acquired in the designated time zone is set in the field of the total number of packets 1324. The number of bytes in the communication log acquired in the designated time zone is set in the field of the total number of bytes 1325. In this embodiment, the log information process 20 and the log compare process 151 are triggered by different execution times so that these processes 20 and 151 are executed independently. Therefore, information indicating “verification result exclusive” is set in the field of the request mode 1323 (step 508) and no information is set in the fields of the statistical algorithm 1326 and the threshold 1327. The “verification result exclusive” in the field of the request mode 1323 means that the log compare process 151 is not executed but the log information process 20 is executed.

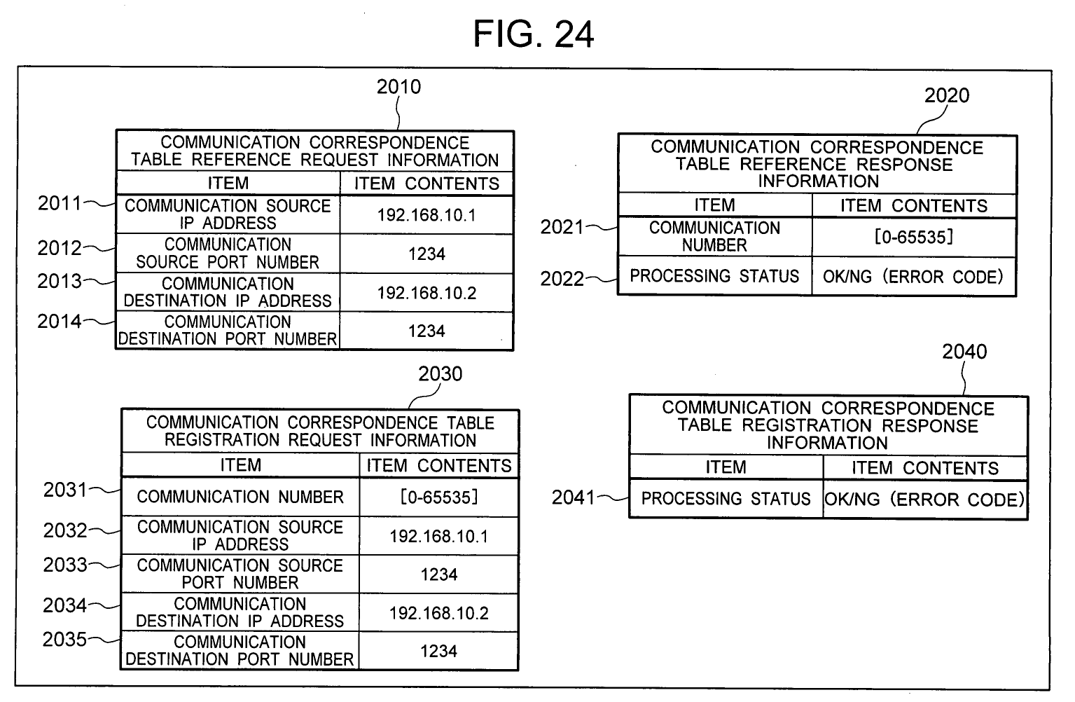

The log management control portion 202 of Log Management Server-A (4) judges whether the log information 121 is received from Client-A (1) or not (step 601). Upon reception of the log information 121, the log management control portion 202 executes a communication correspondence table registration process (step 602). In the communication correspondence table registration process (step 602), the log management control portion 202 extracts the communication source IP address 1312, the communication source port number 1313, the communication destination IP address 1314 and the communication destination port number 1315 from the log information message 1300 in the log information 121 and registers communication correspondence table registration request information 2030 shown in FIG. 24, in the communication correspondence table 205 due to a communication correspondence table registration request 117. Incidentally, the processing portion equivalent to a “communication information management control portion” in the scope of the invention claimed at the time of application is the log management control portion 202 in this embodiment.

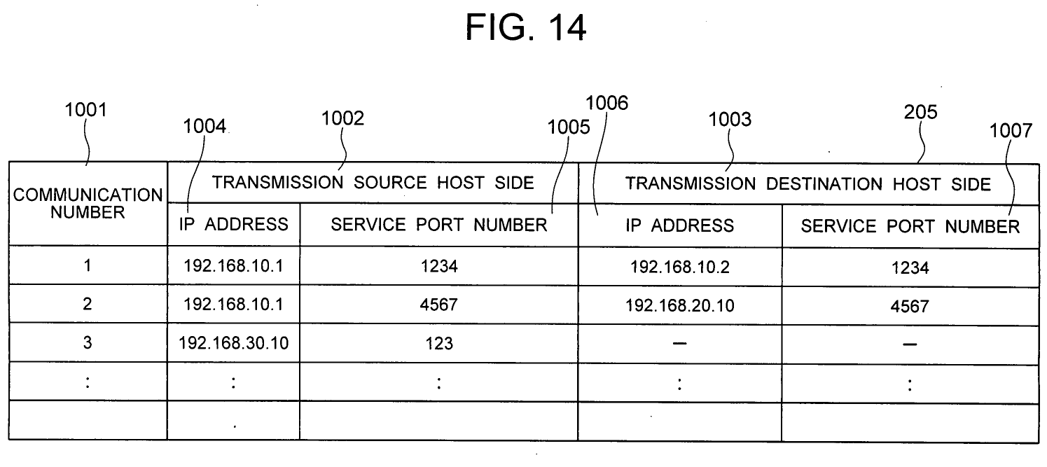

The communication correspondence table registration request information 2030 contains fields of a communication number 2031, a communication source IP address 2032, a communication source port number 2033, a communication destination IP address 2034, and a communication destination port number 2035. As shown in FIG. 14, the communication correspondence table 205 contains fields of a communication number 1001, an IP address 1004 of a communication source host side 1002, a port number 1005 of the communication source host side 1002 for use in inter-peer communication, an IP address 1006 of a communication destination host side 1003, and a port number 1007 of the communication destination host side 1003 for use in inter-peer communication. The communication number 2031, the communication source IP address 2032, the communication source port number 2033, the communication destination IP address 2034 and the communication destination port number 2035 in the communication correspondence table registration request information 2030 are stored in the fields 1001 and 1004 to 1007 of the communication correspondence table 205, respectively.

The communication number 2031 in the communication correspondence table registration request information 2030 is a number for identifying a communication session used in inter-peer communication between Client-A (1) and Application Server-A (2). Log Management Server-A (4) generates the communication number 2301 so that the IP addresses and the port numbers can be uniquely specified between Client-A (1) and Application Server-A (2).

In the communication correspondence table registration process (step 602), the communication source IP address 1312, the communication source port number 1313, the communication destination IP address 1314 and the communication destination port number 1315 contained in the log information message 1300 are registered in the communication correspondence table 205 when they are not present in the communication correspondence table 205, but they are not registered in the communication correspondence table 205 when they are already present in the communication correspondence table 205.

When the communication correspondence table registration process (step 602) is executed, communication correspondence table registration response information 2040 shown in FIG. 24 is sent as a communication correspondence table registration response 118 back to the log management control portion 202. The communication correspondence table registration response information 2040 contains a field of a processing status 2041. When the registration process in the communication correspondence table 205 is executed correctly, “OK” is set in the processing status 2041. Otherwise, an error code indicating “NG” is set in the processing status 2041.

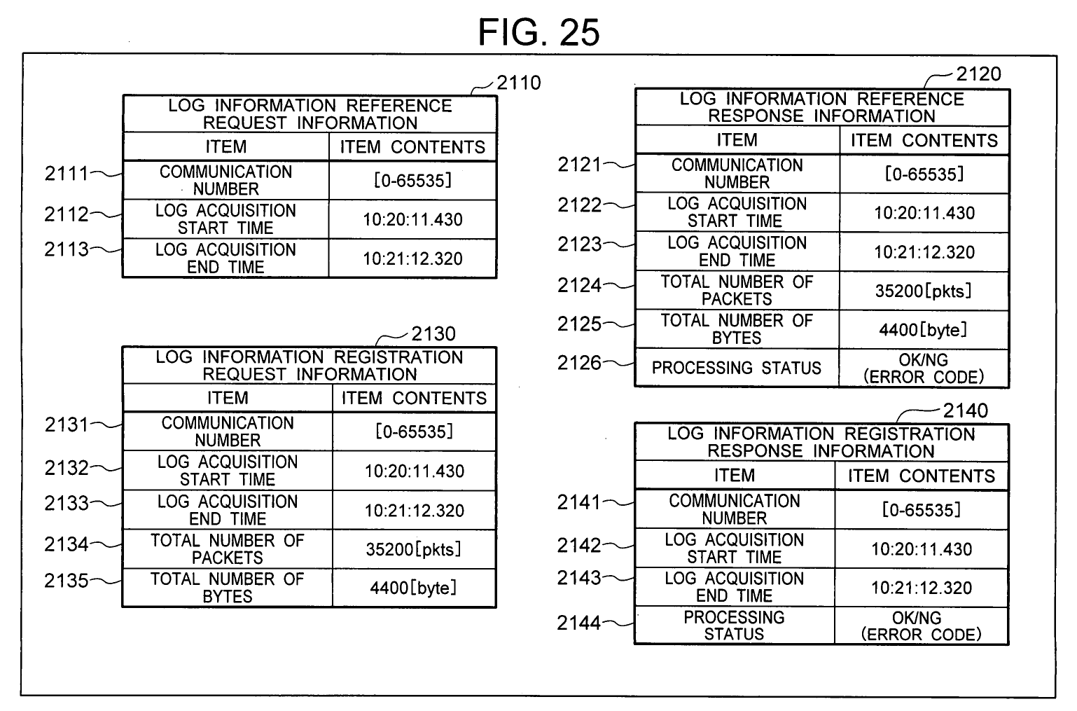

After execution of the communication correspondence table registration process (step 602), the log management control portion 202 executes a log information registration process (step 603). In the log information registration process (step 603), the log management control portion 202 extracts the log acquisition start time 1321, the log acquisition end time 1322, the total number of packets 1324 and the total number of bytes 1325 from the log information message 1300 and registers the contents of log information registration request information 2130 shown in FIG. 25, in the log information table 206 due to a log information registration request 113. As shown in FIG. 14, the log information table 206 contains fields of the communication number 1001, the IP address 1004 of the communication source host side 1002, the port number 1005 of the communication source host side 1002 for use in inter-peer communication, the IP address 1006 of the communication destination host side 1003 and the port number 1007 of the communication destination host side 1003 for use in inter-peer communication. The communication number 2031, the communication source IP address 2032, the communication source port number 2033, the communication destination IP address 2034 and the communication destination port number 2035 in the communication correspondence table registration request information 2030 are stored in the fields 1001 and 1004 to 1007 of the log information table 206, respectively.

As shown in FIG. 25, the log information registration request information 2130 contains fields of a communication number 2131, a log acquisition start time 2132, a log acquisition end time 2133, a total number of packets 2134 and a total number of bytes 2135. The communication number 1101, the log acquisition start time 1102, the log acquisition end time 1103, the number of packets 1104 and the number of bytes 1105 in the log information table 206 are stored in the fields 2131 to 2135 of the log information registration request information 2130, respectively.

The log information registration process (step 603) is executed whenever the log information process 20 is generated newly, so that log information is added to the log information table 206. When the log information registration process (step 603) is executed, a log information registration response 114 is sent back to the log management control portion 202 of Log Management Server-A (4). When the log information registration response 114 is sent back, the log management control portion 202 checks whether “verification result inclusive” is set in the request mode 1323 in the log information message 1300 or not (step 604). When the request mode 1323 is “verification result exclusive”, the log management control portion 202 transmits a log information acknowledgement 122 to SIP Server-A (3). Upon reception of the log information acknowledgement 122, SIP Server-A (3) transmits a log information acknowledgement 102 to Client-A (1) (step 607).

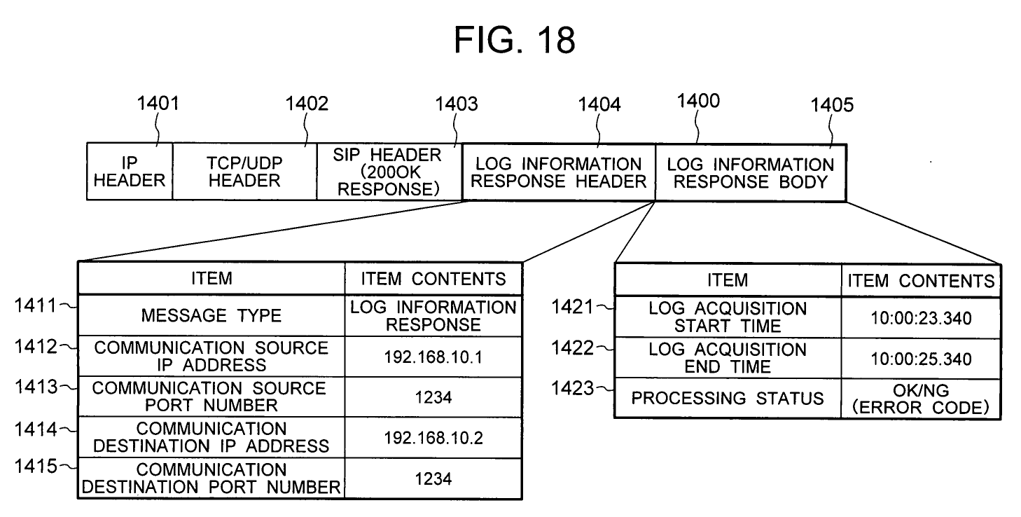

The log information acknowledgement 122 is a log information acknowledgement message 1400 shown in FIG. 18 and stored in an SIP message of a 2000K response. The log information message 1400 contains fields of a log information acknowledgement header 1404 and a log information acknowledgement body 1405. The same information as that of the log information message 1400 in the log information acknowledgement 122 is also stored in the log information 102 transmitted by SIP Server-A (3).

The log information acknowledgement header 1404 contains fields of a message type 1411, a communication source IP address 1412, a communication source port number 1413, a communication destination IP address 1414 and a communication destination port number 1415. Information indicating log information acknowledgement is set in the field of the message type 1411. The IP address 192.168.10.01 and port number 1234 of Client-A (1) transmitting the log information message 101 are set in the fields of the communication source IP address 1412 and the communication source port number 1413, respectively. The IP address 192.168.10.2 and port number 1234 of Application Server-A (2) are set in the fields of the communication destination IP address 1414 and the communication destination port number 1415, respectively.

The log information acknowledgement body 1405 contains fields of a log acquisition start time 1421, a log acquisition end time 1422 and a processing status 1423. The same information as that of the log acquisition start time 1321 and the log acquisition end time 1322 in the log information message 1300 is set in the fields of the log acquisition start time 1421 and the log acquisition end time 1422. “OK” is set in the field of the processing status 1423 when the log information registration process (step 603) is terminated correctly. Otherwise, an error code indicating “NG” is set in the field of the processing status 1423. Upon reception of the log information acknowledgement 102 (step 510), the log management control portion 200 of Client-A (1) resets the execution time of the log acquisition process (step 507).

As described above, in the log information process 20, the inter-peer communication log acquired from Client-A (1) or Application Server-A (2) is stored in the log information table 206 of Log Management Server-A (4). At the same time, information about the inter-peer communication established between Client-A (1) and Application Server-A (2) is registered in the communication correspondence table 205 of Log Management Server-A (4).

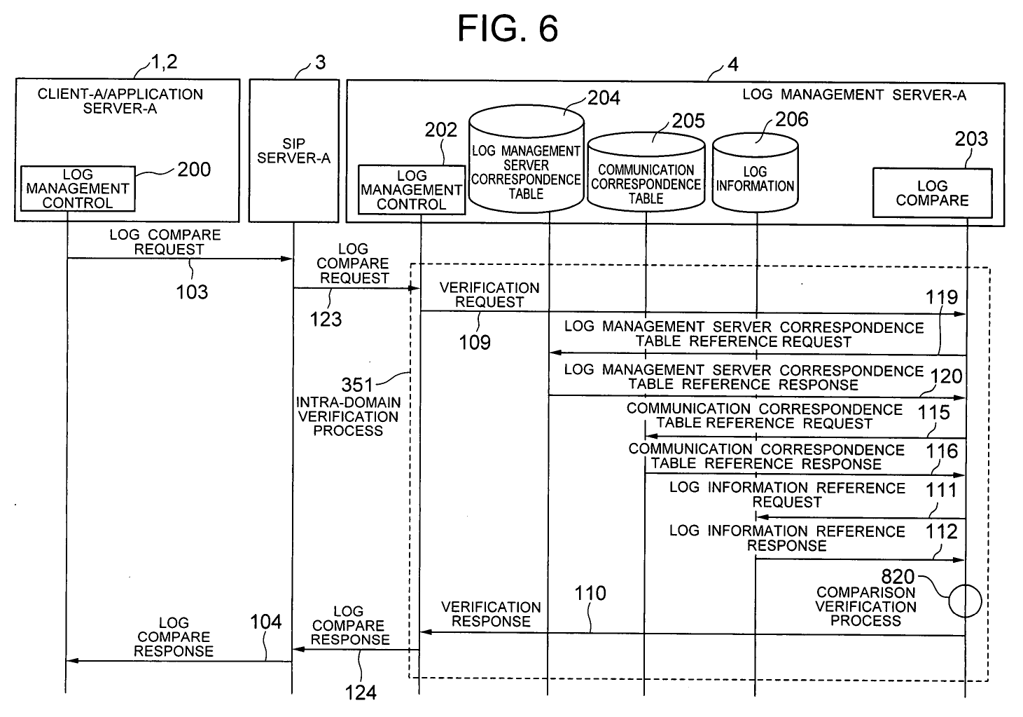

Next, the log compare process 151 according to the embodiment will be described. A sequence of the log compare process 151 is shown in FIG. 6. Here, the log compare process 151 will be described in the case where Client-A (1) in Domain-A (5) shown in FIG. 1 communicates with Application Server-A (2) belonging to the same Domain-A (5) in an inter-peer communication manner and Client-A (1) transmits a log compare request 103 to Log Management Server-A (4). Incidentally, the same processing can be applied to the case where Application Server-A (2) transmits a log compare request 103 to Log Management Server-A (4) for inter-peer communication with Client-A (1).

In the same manner as in the log information process 20, the log management control portion 200 of Client-A (1) judges whether the present time is coincident with a processing execution time in the log compare process 151 or not (step 511). When the present time is coincident with the processing execution time, the log management control portion 200 of Client-A (1) transmits the log compare request 103 to SIP Server-A (3) and SIP Server-A (3) transfers the log compare request 103 as a log compare request 123 to Log Management Server-A (4) (step 512).

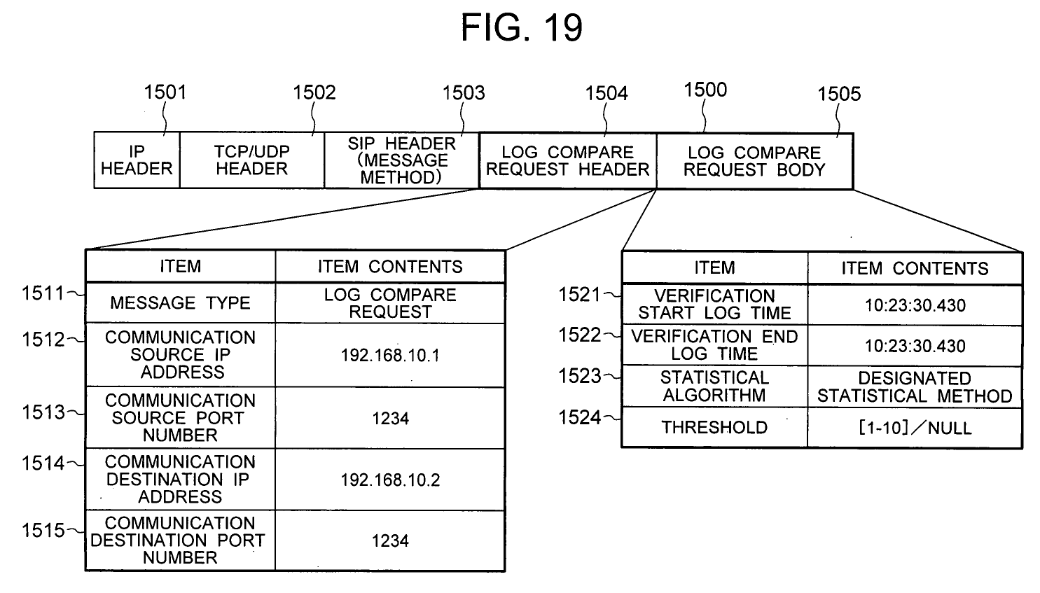

The log compare request 103 is a log compare request message 1500 shown in FIG. 19 and stored as an SIP message of the message method. The log compare request message 1500 contains fields of a log compare request header 1504 and a log compare request body 1505. The same log compare request message 1500 as that in the log compare request 103 is stored also in the log compare request 123 transferred by SIP Server-A (3).

The log compare request header 1504 contains fields of a message type 1511, a communication source IP address 1512, a communication source port number 1513, a communication destination IP address 1514 and a communication destination port number 1515. The log compare request body 1505 contains fields of a verification start log time 1521, a verification end log time 1522, a statistical algorithm 1523 and a threshold 1524. Information indicating log compare request is set in the filed of the message type 1421. The IP address 192.168.10.01 and port number 1234 of Client-A (1) are set in the fields of the communication source IP address 1512 and the communication source port number 1513, respectively. The IP address 192.168.10.02 and port number 1234 of Application Server-A (2) are set in the fields of the communication destination IP address 1514 and the communication destination port number 1515, respectively.

The log compare request body 1505 contains the fields of the verification start log time 1521, the verification end log time 1522, the statistical algorithm 1523 and the threshold 1524. A start time and an end time in a time zone to be verified are set in the fields of the verification start log time 1521 and the verification end log time 1522, respectively. A statistical algorithm and a threshold to be used for log compare are set in the fields of the statistical algorithm 1523 and the threshold 1524, respectively.

The log management control portion 202 of Log Management Server-A (4) judges whether the log compare request 123 is received from SIP Server-A (3) or not (step 608). Upon reception of the log compare request 123, the log management control portion 202 acquires the verification start log time 1521, the verification end log time 1522, the statistical algorithm 1523 and the threshold 1524 from the log compare request message 1500 which is shown in FIG. 19 and which is contained in the log compare request 123, and the log management control portion 202 sends verification request information 1930 as a verification request 109 to the log compare portion 203 of Log Management Server-A (4) (step 609).

The verification request information 1930 contains fields of a communication source IP address 1931, a communication source port number 1932, a communication destination IP address 1933, a communication destination port number 1934, a verification start log time 1935, a verification end log time 1936, a statistical algorithm 1937 and a threshold 1938. Information about the communication source IP address 1512, the communication source port number 1513, the communication destination IP address 1514, the communication destination port number 1515, the verification start log time 1521, the verification end log time 1522, the statistical algorithm 1523 and the threshold 1524 in the log compare request message 1500 are set in the fields 1931 to 1938 of the verification request information 1930, respectively.

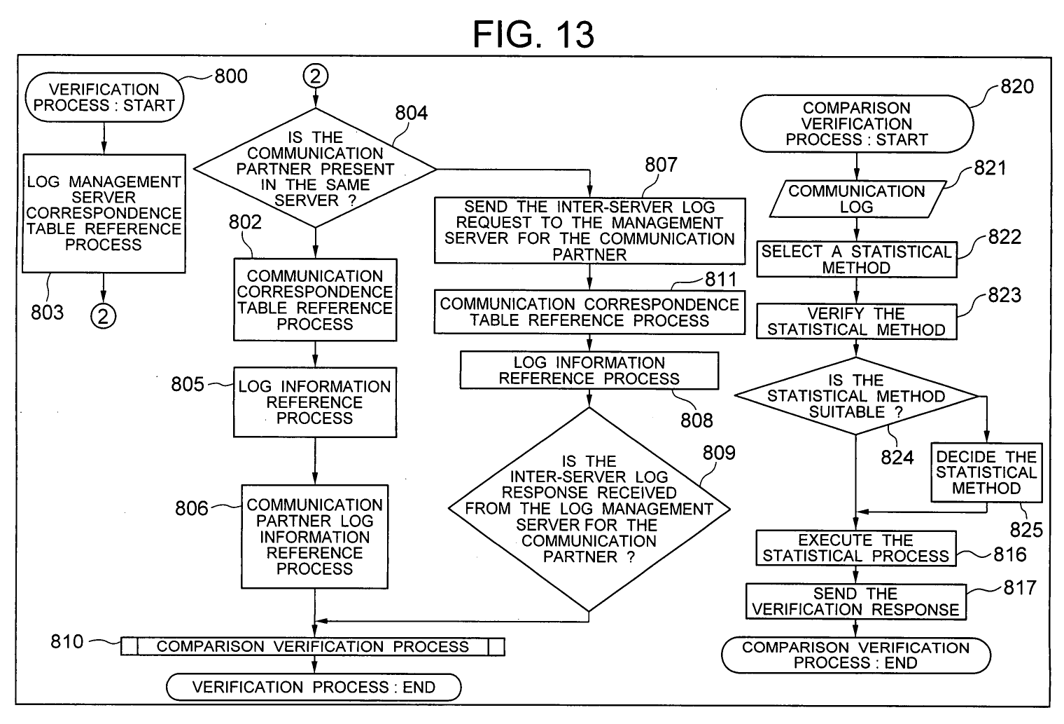

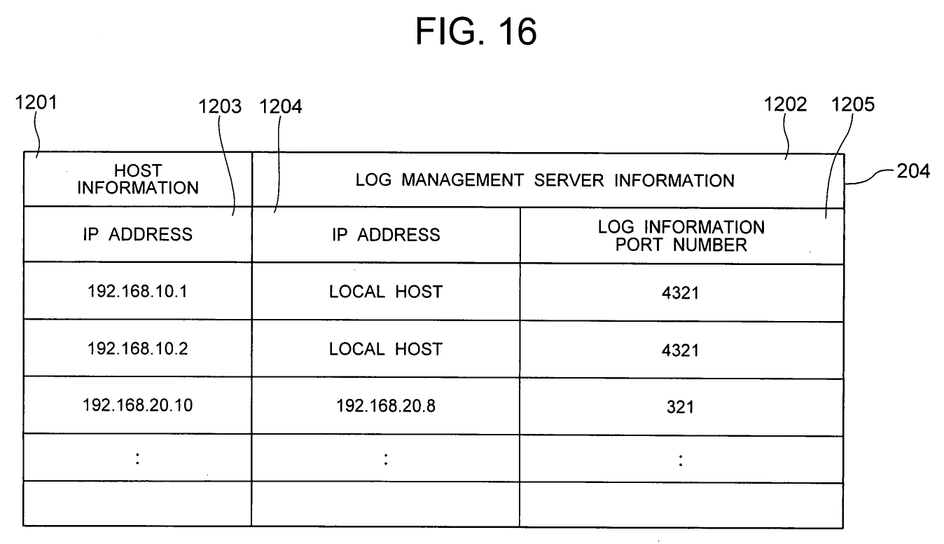

A flow of the verification process in the log compare portion is shown in a flow chart 800 of FIG. 13. In the verification process, a log management server correspondence table reference process (step 803) is first executed due to a log management server correspondence table reference request 119. In the log management server correspondence table reference process (step 803), the log management server correspondence table 204 is referred to so that log management servers to which Client-A (1) and Application Server-A (2) belong can be specified. As shown in FIG. 16, the log management server correspondence table 204 contains the field of an IP address 1203 in host information 1201, and the fields of an IP address 1204 and a log information port number 1205 in log management server information 1202. In the log management server correspondence table reference process (step 803), respective log management servers for Client-A (1) and Application Server-A (2) as a communication source and a communication destination are referred to so that a judgment can be made as to whether Client-A (1) as a communication source and Application Server-A (2) as a communication destination belong to the same Log Management Server-A (4) or not (step 804). In this embodiment, since Client-A (1) and Application Server-A (2) belong to the same Log Management Server-A (4), the communication correspondence table reference process (step 802) is executed on Client-A (1) and Application Server-A (2) to acquire a communication number 1001.

In the communication correspondence table reference process (step 802), a communication session coincident in terms of the communication source IP address 1931, the communication source port number 1932, the communication destination IP address 1933 and the communication destination port number 1934 provided to the log compare portion 203 in response to a verification request 109 is retrieved from the communication correspondence table 205 to thereby acquire the communication number 1001. As shown in FIG. 24, a communication correspondence table reference request 115 issued by the log compare portion 203 in the communication correspondence table reference process (step 802) contains communication correspondence table reference request information 2010. Pieces of information about the communication source IP address 1931, the communication source port number 1932, the communication destination IP address 1933, and the communication destination port number 1934 contained in the verification request information 1930 in FIG. 23 are set in fields of a communication source IP address 2011, a communication source port number 2012, a communication destination IP address 2013 and a communication destination port number 2014 in the communication correspondence table reference request information 2010, respectively. In this embodiment, the IP address 168.192.10.1 of Client-A (1) is set in the field of the communication source IP address 2011. The port number 1234 of Client-A (1) for use in inter-peer communication is set in the field of the communication source port number 2012. The IP address 168.192.10.2 of Application Server-A (2) is set in the field of the communication destination IP address 2013. The port number 1234 of Application Server-A (2) for use in inter-peer communication is set in the field of the communication destination port number 2014.

When the communication correspondence table reference process (step 802) is completed, the communication correspondence table reference response 116 is sent back to the log compare portion 203. The log compare portion 203 executes log information reference processes (steps 805 and 806) for Client-A (1) and Application Server-A (2), respectively. The log information reference processes (steps 805 and 806) are executed due to a log information reference request 111. The log information reference request 111 contains fields of a communication number 2111, a log acquisition start time 2112 and a log acquisition end time 2113 as log information reference request information 2110 shown in FIG. 25. The communication number 2021 sent back in the communication correspondence table reference response 116, the verification start log time 1935 and the verification end log time 1936 sent in the verification request 109 are set in the fields 2111 to 2113 of the log information reference request information 2110, respectively. Log information coincident in terms of the communication number 2111 is acquired from the log information table 206 due to the log information reference request 111 and sent as a log information reference response 112 back to the log compare portion 203.

Log information reference response information 2120 shown in FIG. 25 is stored in the log information reference response 112. The communication number 1101, the log acquisition start time 1102, the log acquisition end time 1103, the number of packets 1104 and the number of bytes 1105 shown in the log information table 206 are stored in the fields of the communication number 2121, the log acquisition start time 2122, the log acquisition end time 2123, the total number of packets 2124 and the total number of bytes 2125 in the log information reference response information 2120, respectively. When the log information reference processes (steps 805 and 806) are completed correctly, “OK” is set in the processing status 2126 in the log information reference response information 2120. Otherwise, an error code indicating “NG” is set in the processing status 2126.

When the log information reference response 112 is sent back to the log compare portion 203, a comparison verification process 820 is executed. A procedure in the comparison verification process 820 is shown in a comparison verification process flow chart 820 shown in FIG. 13. In the comparison verification process 820, when the information acquired from the log information table 206 is input as a communication log (step 821), a designated statistical method is selected (step 822). The statistical method is verified (step 823) so that decision is made as to whether the selected statistical method is suitable or not (step 824).

This process performs verification so that decision is made as to whether the selected statistical method can be applied to the input communication log or not. For example, the basic statistic of the communication log is calculated to verify whether the basic statistic has a normal distribution or not. Or the number of data in the communication log is counted to verify whether the number of data satisfies a designated number of samples or not. Examination is performed on the basis of a result of the verification as to whether the designated statistical method can be applied or not.

When the designated statistical method can be applied, the statistical process is executed in accordance with the designated statistical method (step 816). On the other hand, when the designated statistical method cannot be applied, a statistical method decision process (step 825) is performed so that a statistical method corresponding to the feature of the communication log notified by the log information reference response 112 is decided from standard statistic methods predetermined in Log Management Server-A (4), and then, the statistical process is executed (step 816).

In execution of the statistical process (step 816), calculation is performed by a statistical formula or a testing method corresponding to the selected statistical method. Comparison is performed by use of a result of the calculation and the threshold 1524 acquired from the log compare request message 1500 notified from Client-A (1) or Application Server-A (2). When the designated statistical method cannot be applied on this occasion, Log Management Server-A (4) sets a value corresponding to the default statistical method as the threshold used.

When the comparison verification process 820 is executed, the log compare portion 203 sends a verification response 110 back to the log management control portion 202 (step 817). The verification response 110 contains fields of a statistical algorism 1941, a verification result 1942 and a processing status 1943 as represented by verification response information 1940 in FIG. 23.

The statistical method used in the comparison verification process 820 is set in the statistical algorism 1941. A judgment level expressed by a numerical value of from 0 to 10 is set in the verification result 1942. When the comparison verification process is terminated correctly, “OK” is set in the processing status 1943. Otherwise, an error code indicating “NG” is set in the processing status 1943. A numerical value corresponding to the threshold in accordance with the statistical method is set in the judgment level stored in the verification result 1942. Log Management Server-A (4) decides an allowable range, a significance level of verification, etc. concerned with the difference in communication quantity between Client-A (1) and Application Server-A (2) in accordance with the threshold.

Upon reception of the verification result from the verification response 104, Client-A (1) can know a specific numerical value of the range indicated by the threshold corresponding to the judgment level when confirming the value set on Log Management Server-A (4).

Upon reception of the verification response 110, the log management control portion 202 sends a log compare response 124 to SIP Server-A (3). SIP Server-A (3) transfers the log compare response 124 as a log compare response 104 to Client-A (1) (step 610).

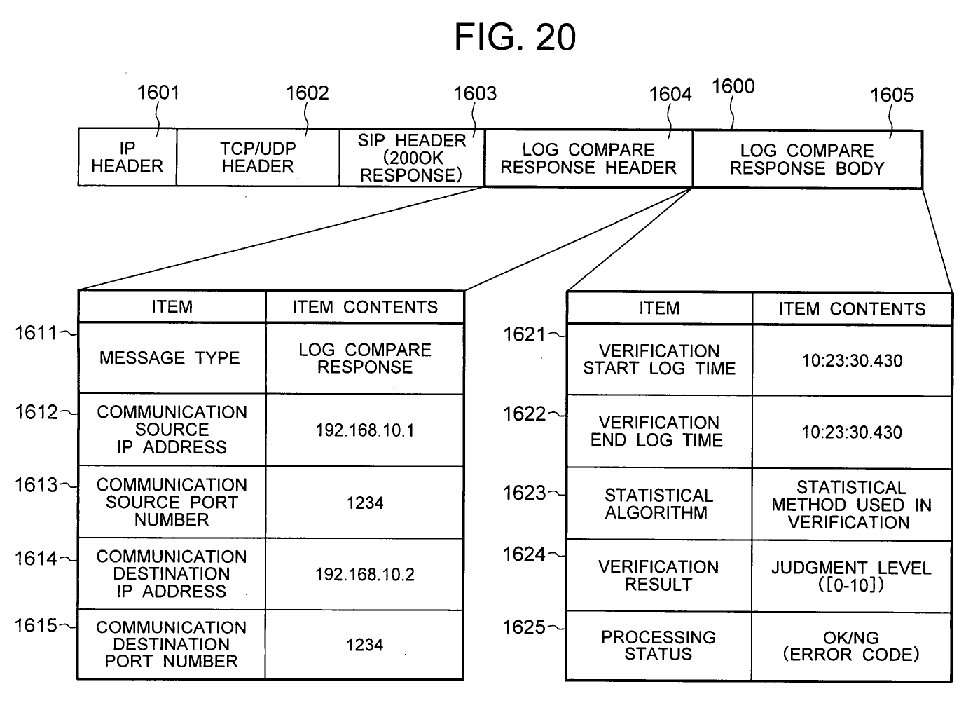

The log compare response 124 is a log compare response message 1600 which is shown in FIG. 20 and which is stored in an SIP message of a 2000K response. The log compare response 124 contains a log compare response header 1604, and a log compare response body 1605. Incidentally, the log compare response 104 contains the same information as that of the log compare response message 1600 in the log compare response 124.

The log compare response header 1604 contains information fields of a message type 1611, a communication source IP address 1612, a communication source port number 1613, a communication destination IP address 1614 and a communication destination port number 1615. Information indicating the log compare response message 1600 is set in the field of the message type 1611. The same contents as the contents 1512 to 1515 of the log compare request header 1504 in the log compare request message 1500 are set in the other fields of the log compare response header 1604.

The log compare response body 1605 contains fields of a verification start log time 1621, a verification end log time 1622, a statistical algorism 1623, a verification result 1624 and a processing status 1625. The verification start log time 1521 and the verification end log time 1522 in the log compare request body 1505 of the log compare request message 1500 are set in the verification start log time 1621 and the verification end log time 1622, respectively. The same pieces of information as the statistical algorism 1941, the verification result 1942 and the processing status 1943 in the verification response information 1940 are set in the statistical algorism 1623, the verification result 1624 and the processing status 1625, respectively.

The log management control portion 200 of Client-A (1) judges whether the log compare response 104 is received or not (step 513). Upon reception of the log compare response 104, the log management control portion 200 of Client-A (1) outputs a result of the judgment to a log file or terminal on Client-A (1) (step 514). The execution time for the log compare process 151 is set newly again (step 515).

The log management server manages only log information notified from clients and application servers belonging to a domain including the log management server. For this reason, when the client or application server issuing the log compare request 103 belongs to a domain different from the domain including the application server or client as a communication partner, a process of acquiring log information from a log management server which manages the different domain is required in the log compare process 151.

Processing will be described below in the case where Client-A (1) of Domain-A (5) shown in FIG. 1 communicates with Application Server-B (10) of Domain-B (11) in an inter-peer communication manner and Client-A (1) transmits a log compare request 103 to Log Management Server-A (4). Incidentally, the same processing can be applied to the log compare process 151 in the case where Application Server-A (2) communicates with Client-B (9) of Domain-B (11) in an inter-peer communication manner.

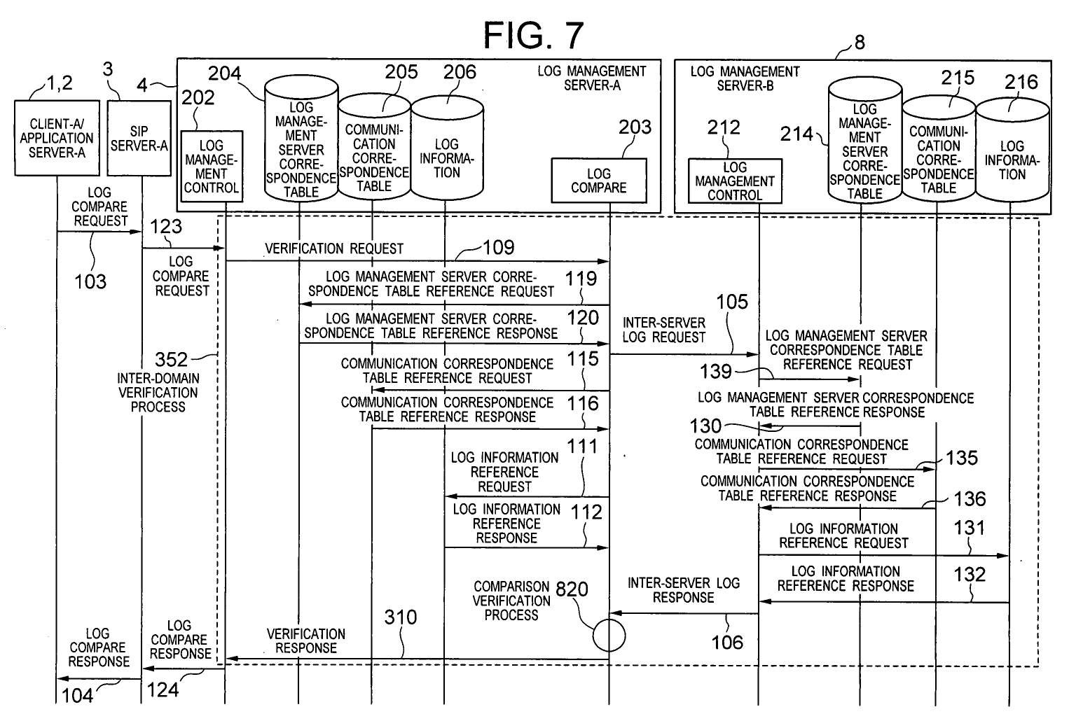

FIG. 7 shows a sequence in the case where Client-A (1) and Application Server-B (10) communicate with each other in an inter-peer communication manner and Client-A (1) executes the log compare process 151 for Log Management Server-A (4). In the sequence in the log compare process 151 shown in FIG. 7, the log management control portion 202 of Log Management Server-A (4) judges whether a log compare request 123 is received from Client-A (1) or not (step 608). Upon reception of the log compare request 123, the log management control portion 202 of Log Management Server-A (4) issues a verification request 109 to the log compare portion 203 of Log Management Server-A (4) (step 609).

Upon reception of the verification request 109, the log compare portion 203 executes a log management server correspondence table reference process (step 803). The log management server correspondence table reference process (step 803) is a process for specifying which log management server includes Application Server-B (10) as a communication partner. In this embodiment, since Application Server-B (10) is registered on Log Management Server-B (8), the log compare portion 203 sends an inter-server log request 105 to Log Management Server-B (8) which manages Application Server-B (10).

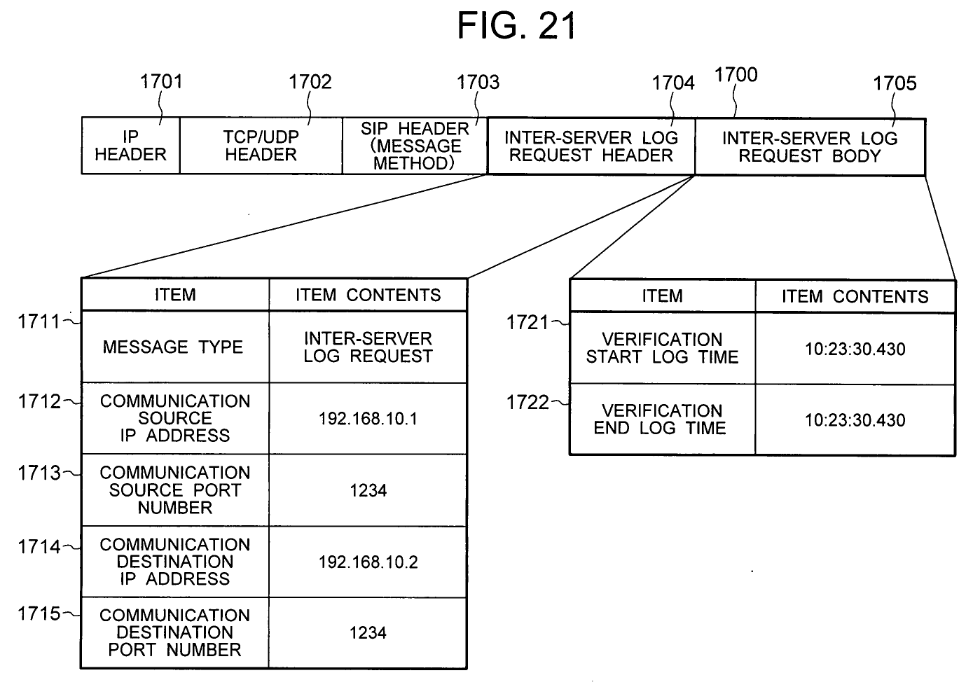

As shown in FIG. 21, the inter-server log request 105 is an inter-server log request message 1700 stored in an SIP message of a message method. The inter-server log request message 1700 contains an inter-server log request header 1704, and an inter-server log request body 1705. The inter-server log request header 1704 contains fields of a message type 1711, a communication source IP address 1712, a communication source port number 1713, a communication destination IP address 1714 and a communication destination port number 1715. Information indicating the inter-server log request message 1700 is set in the field of the message type 1711. The IP address 192.168.10.1 and port number 1234 of Client-A (1) are set in the communication source IP address 1712 and the communication source port number 1713, respectively. The IP address 192.168.20.10 and port number 1234 of Application Server-B (10) are set in the communication destination IP address 1714 and the communication destination port number 1715, respectively. The inter-server log request body 1705 contains fields of a verification start log time 1721 and a verification end log time 1722. The same pieces of information as the verification start log time 1521 and the verification end log time 1522 in the log compare request message 1500 transmitted by Client-A (1) are set in the verification start log time 1721 and the verification end log time 1722, respectively.

After transmission of the inter-server log request 105 to Log Management Server-B (8), Log Management Server-A (4) executes a communication correspondence table reference process (step 811) and a log information reference process (step 808) to acquire log information of Client-A (1). On the other hand, upon reception of the inter-server log request 105 (step 611), Log Management Server-B (8) executes a log management server correspondence table reference process (step 615) due to a log management server correspondence table reference request 139. After execution, a log management server correspondence table reference response 130 is sent back to the log management control portion 212 on Log Management Server-B (8).

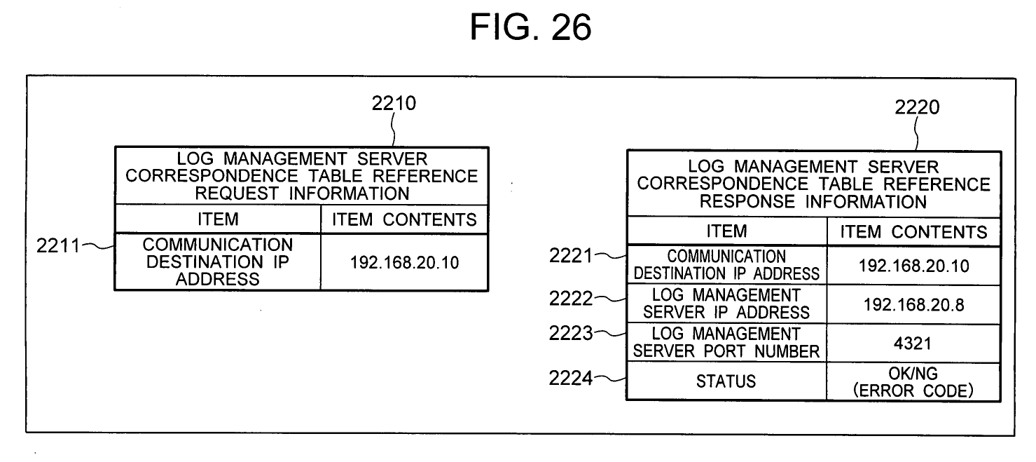

Log management server correspondence table reference request information 2210 shown in FIG. 26 is stored in the log management server correspondence table reference request 139. The communication destination IP address 2211 is set in the log management server correspondence table reference request information 2210. The communication destination IP address 1714 contained in the inter-server log request message 1700 is set in the communication destination IP address 2211. The communication destination IP address 2211 is retrieved as to whether the communication destination IP address 2211 is present in a list of IP addresses 1203 in host information 1201 of the log management server correspondence table 204 or not. When the communication destination IP address 2211 is present, it is confirmed on the basis of corresponding log management server information 1202 that the IP address 1204 specifies Log Management Server-B (8).

Log management server correspondence table reference response information 2220 shown in FIG. 26 is stored in the log management server correspondence table reference response 130. The log management server correspondence table reference response information 2220 contains fields of a communication destination IP address 2221, a log management server IP address 2222, a log management server port number 2223 and a processing status 2224. The communication destination IP address 2211 contained in the log management server correspondence table reference request 139 is set in the communication destination IP address 2221. The IP address 1204 and log information port number 1205 in the log management server information 1202 specified from the log management server correspondence table 204 are set in the log management server IP address 2222 and the log management server port number 2223, respectively. When the log management server reference process is executed correctly, “OK” is set in the processing status 2224. Otherwise, an error code indicating “NG” is set in the processing status 2224.

In this embodiment, the IP address 192.168.20.10 of Application Server-B (10) is set both in the communication destination IP address 2211 in the log management server correspondence table reference request information 2210 and in the communication destination IP address 2221 in the log management server correspondence table reference response information 2220. The IP address 192.168.20.8 and port number of Log Management Server-B (8) are set in the log management server IP address 2222 and the log management server port number 2223, respectively. When the log management server specified by the communication destination IP address 2211 is Log Management Server-B (8), a communication correspondence table reference process (step 612) and a log information reference process (step 613) are executed. These processes are equal in procedure to the communication correspondence table reference process (step 802) and the log information reference process (step 805).

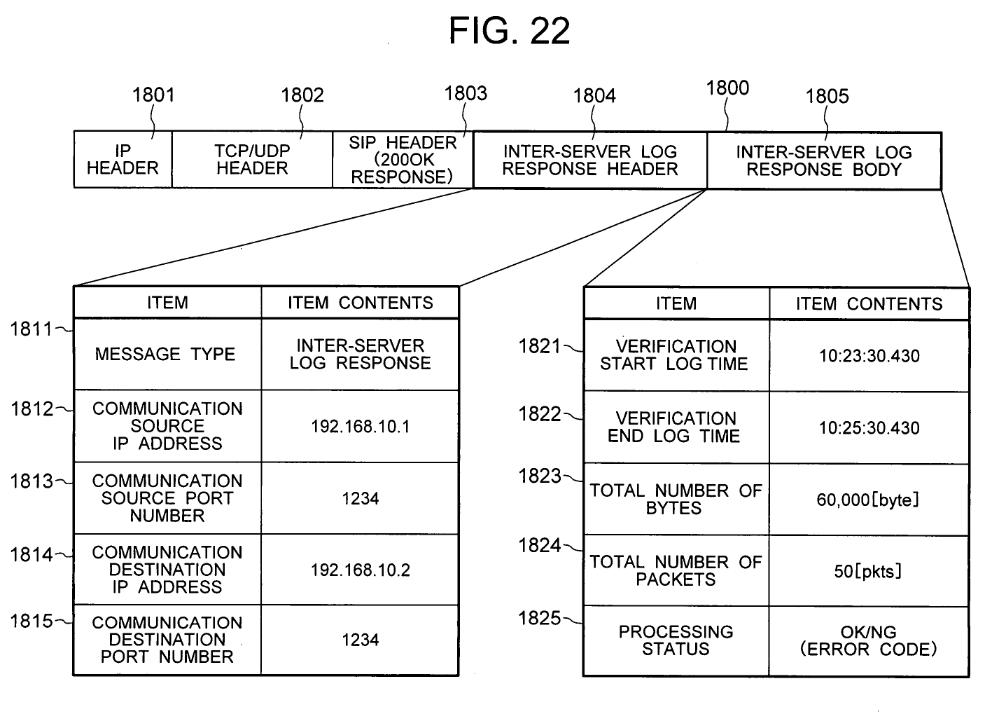

After execution of the log information reference process (step 613), the log management control portion 212 of Log Management Server-B (8) transmits an inter-server log response 106 to Log Management Server-A (4) (step 614). As shown in FIG. 22, the inter-server log response 106 is an inter-server log response message 1800 stored in an SIP message of a 2000K response. The inter-server log response message 1800 contains an inter-server log response header 1804, and an inter-server log response body 1805. The inter-server log response header 1804 contains information fields of a message type 1811, a communication source IP address 1812, a communication source port number 1813, a communication destination IP address 1814 and a communication destination port number 1815. Information indicating the inter-server log response message is set in the field of the message type 1811. The same pieces of information 1712 to 1715 as the inter-server log request header 1704 of the inter-server log request message 1700 are set in the other fields of the inter-server log response header 1804. The inter-server log response body 1805 contains fields of a verification start log time 1821, a verification end log time 1822, a total number of bytes 1823, a total number of packets 1824 and a processing status 1825. The verification start log time 1721 and the verification end log time 1722 in the inter-server log request message 1700 are set in the verification start log time 1821 and the verification end log time 1822, respectively. The total number of packets 2124, the total number of bytes 2125 and the processing status 2126 in the log information reference response information 2120 are set in the total number of packets 1824, the total number of bytes 1823 and the processing status 1825, respectively.

The log compare portion 203 of Log Management Server-A (4) judges whether the inter-server log response 106 is received from Log Management Server-B (8) or not (step 809). Upon reception of the inter-server log response 106, the log compare portion 203 executes a comparison verification process 820. The comparison verification process 820 is executed by use of the log information of Application Server-B (10) and the log information of Client-A (1) contained in the inter-server log response message 1800. A result of the execution is stored as verification response information 1940 in a verification response 110 and sent to the log management control portion 202. The procedure after this point of time is equal to that in the log compare process 151.

Although the embodiment has been described on the case where the log information process 20 and the log compare process 151 are executed at different processing execution times respectively, there may be conceived a method in which the log information process 20 and the log compare process 151 are executed at the same execution time so that verification results of the log compare responses 104 and 124 are contained in the log information acknowledgements 122 and 102, in order to reduce the quantity of traffic due to the log information request 101 and the log compare request 103. In this case, when a client 1 or 9 or an application server 2 or 10 sends a log information request 101 to a log management server 4 or 8, the log management server 4 or 8 sends a log compare response 104 to the client 1 or 9 or the application server 2 or 10. A procedure in the case where the log information process 20 and the log compare process 151 are executed at the same execution time will be described with reference to Embodiment 2.

### Embodiment 2

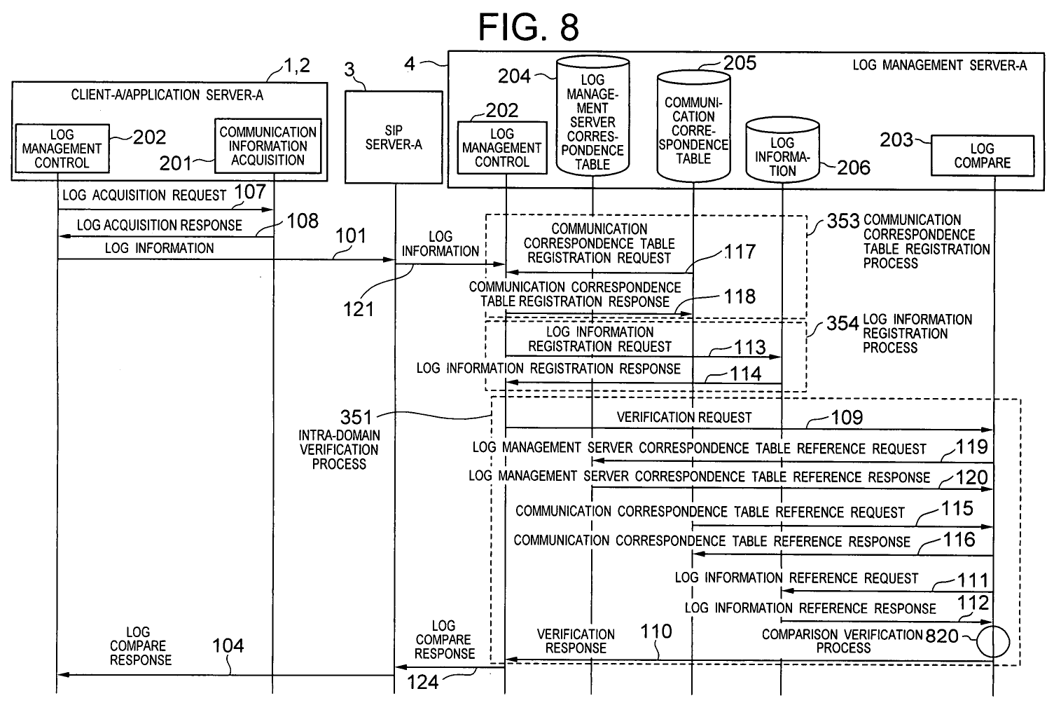

FIG. 8 shows a sequence in the case where the log information process 20 and the log compare process 151 are executed at the same execution time. The log management control portion 200 of Client-A (1) judges whether the present time is an execution time of a log acquisition process or not (step 501). When the present time is an execution time of a log acquisition process, the log management control portion 200 issues a log acquisition request 107 to the communication information acquisition portion 201 (step 502). The communication information acquisition portion 201 executes a log acquisition process 700 and sends a log acquisition response 108 to the log management control portion 200. Upon reception of the log acquisition response 108, the log management control portion 200 judges whether the log compare process 151 is executed concurrently or not (step 503). In this embodiment, since the log compare process 151 is executed concurrently, “verification result inclusive” is set in the request mode 1323 in the log information message 1300 (step 504). After a statistical method decided by Client-A (1) is set in the statistical algorism 1326 and a threshold decided by Client-A (1) is set in the threshold 1327, a log information 101 is sent to SIP Server-A (3). SIP Server-A (3) transmits a log information 121 containing the same information as the log information message 1300 to Log Management Server-A (4) (step 505).

The log management control portion 202 on Log Management Server-A (4) judges whether the log information 121 transmitted by SIP Server-A (3) is received or not (step 601). Upon reception of the log information 121, the log management control portion 202 executes a communication correspondence table registration process (step 602) and then executes a log information registration process (step 603). Upon reception of a log information registration response 114, the log management control portion 202 judges whether information of the request mode 1323 in the log information message 1300 is “verification result inclusive” or not (step 604). In this embodiment, since the information is “verification result inclusive”, the log management control portion 202 executes an intra-domain verification process 351 due to the log compare portion 203 (step 605). The intra-domain verification process 351 due to the log compare portion 203 is the same as the intra-domain verification process 351 in FIG. 6 described in

### Embodiment 1

Upon reception of the verification response 110, the log management control portion 202 transmits a log compare response 124 to SIP Server-A (3). SIP Server-A (3) transfers the log compare response 124 as a log compare response 104 to Client-A (1) (step 606). Upon reception of the log compare response 104 (step 506), the log management control portion 200 of Client-A (1) outputs a result of the log compare process 151 to a terminal, a log file or the like (step 516) and sets the execution time of the log acquisition process again (step 507).

Although the aforementioned operation is carried out in the case where both the client and the application server belong to the same domain, a different operation is carried out in the verification process of the log management server in the same manner as in Embodiment 1 in the case where the client and the application server belong to different log management servers respectively.

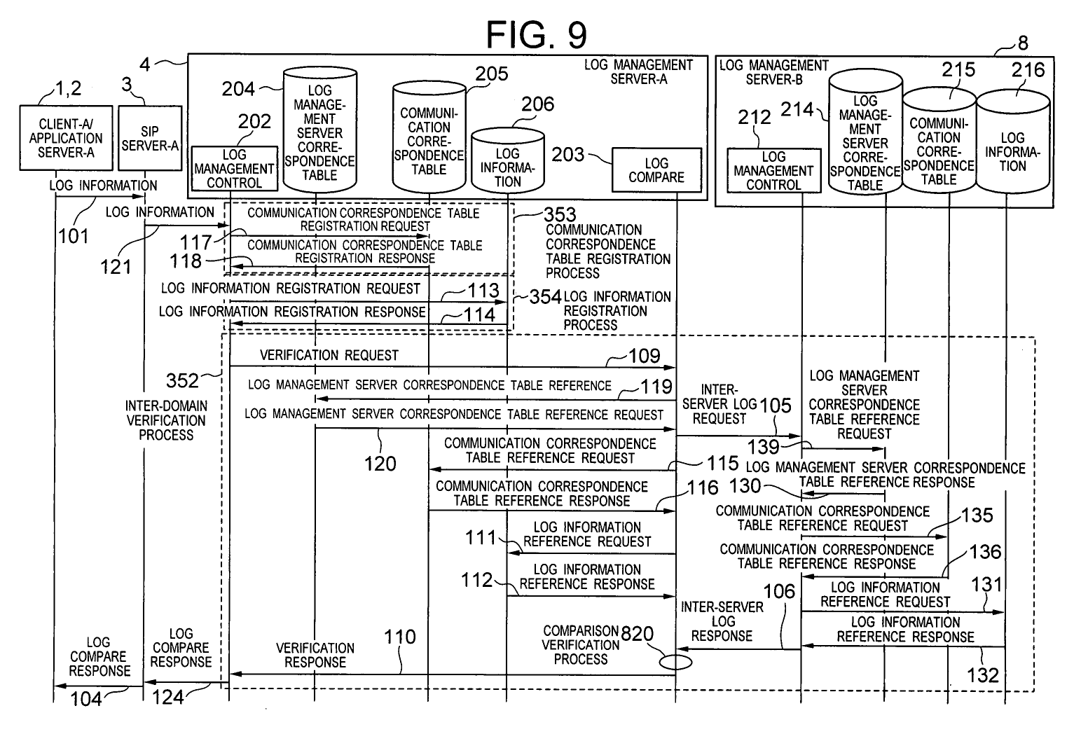

FIG. 9 shows a sequence in the case where the client and the application server belong to different domains respectively. Here, processing will be described in the case where Client-A (1) of Domain-A (5) shown in FIG. 1 communicates with Application Server-B (10) of Domain-B (11) in an inter-peer communication manner and Client-A (1) transmits a log information 101 to Log Management Server-A (4). Incidentally, the same processing can be applied to the case where Application Server-A (2) communicates with Client-B (9) of Domain-B (11) in an inter-peer communication manner and Application Server-A (2) transmits a log information 101 to Client-B (9).

In FIG. 9, such a procedure that Client-A (1) transmits a log information message 1300 to Log Management Server-A (4) via SIP Server-A (3) and the log management control portion 202 of Log Management Server-A (4) executes a communication correspondence table registration process (step 602) and a log information registration process (step 603) is the same as the procedure in the case where the client and the application server belong to the same domain.

Upon reception of a log information registration response 114 of the log information registration process (step 603), the log management control portion 202 of Log Management Server-A (4) executes an inter-domain verification process 352 described in Embodiment 1. Upon reception of a verification response 110, the log management control portion 202 transmits a log compare response 124 to SIP Server-A (3). SIP Server-A (3) transfers the log compare response 124 as a log compare response 104 to Client-A (1).

If the log information process 20 and the log compare process 151 are not carried out on a confidential communication path, a problem about leaking of privacy information of clients 1 and 9 and incorrect accounting due to application servers 2 and 10 will be caused by falsification and wiretapping. It is therefore preferable that messages exchanged between the client 1 (or 9) or the application server 2 (or 10) and the log management server 4 (or 8) in the log information process 20 and the log compare process 151 are encrypted. In an encryption process in a general communication path, an authentication process using public-key cryptography is carried out to deliver a common key necessary for encryption. The load due to the authentication process is however heavy. In the invention, the load due to the authentication process necessary for encryption of a communication path can be lightened by use of SIP.

The case where HTTP is applied to the invention will be described as an example. In HTTP, a procedure of from an HTTP request to an HTTP response forms a communication session. For this reason, in the case where a communication path due to HTTP is encrypted, the encrypted communication path established by the HTTP request is cut off when the HTTP response is transmitted. In the case where HTTP is applied to the invention, an HTTP request is used as a request transmitted from a client 1 (or 9) or an application server 2 (or 10) to a log management server 4 (or 8) while an HTTP response is used as a response to the request. The HTTP request and the HTTP response are stored in packets. For this reason, a process of establishing a session for communication with the log management server and a process of cutting off the session arise whenever the client 1 (or 9) or the application server 2 (or 10) transmits the log information 101 or the log compare request 103 periodically. Accordingly, the authentication process necessary for encryption of the communication path is carried out whenever the process of establishing the session arises. In the invention, use of HTTP is not suitable for encryption of the communication path because the log information process 20 and the log compare process 151 arise periodically.

On the contrary, SIP has a function of controlling and managing a communication session in inter-peer communication or inter-client communication. For this reason, when a client 1 (or 9) or an application server 2 (or 10) once requests an SIP server 3 (or 7) to establish a session in inter-peer communication or inter-client communication, the session can be retained until the client 1 (or 9) or the application server 2 (or 10) requests the SIP server 3 (or 7) to cut off the session. Accordingly, when the client 1 (or 9) or the application server 2 (or 10) is once authenticated by the SIP server 3 (or 7) at the time of start of connection in inter-peer communication, messages can be transmitted via the same encrypted communication path. Accordingly, the load due to authentication is so light that the response time for each process request can be shortened compared with the case where HTTP is used.

The invention need not use SIP. The invention can be operated by an existing protocol such as HTTP or by a newly designed protocol. When SIP is used, the aforementioned advantage can be obtained.

Incidentally, in the invention, authentication may be performed between a client 1 (or 9) (or an application server 2 (or 10)) and an SIP server 3 (or 7) to establish an encrypted communication path in advance. When inter-peer communication between the client 1 (or 9) and the application server 2 (or 10) is newly encrypted through the established encrypted communication path, the client 1 (or 9) (or an application server 2 (or 10)) can transmit messages to the log management server 4 (or 8) via the newly encrypted communication path directly.

In the invention, a client and an application server periodically repeatedly and periodically notify a reliable management server of communication logs collected at the same time that inter-peer communication starts. The management server verifies consistency between the communication logs to thereby warrant validity of the inter-peer communication. At a point of time when inconsistency occurs in the communication logs, the client or the application server can find the inconsistency. Illegal use of the service user and accounting for an unreasonable fee from the service provider can be prevented.

Because the management server which collects and verifies the notified communication logs operates independent of the application server which provides service, the management server can concentrate its energy on the function of collecting the communication logs and verifying consistency between the communication logs. The load can be prevented from being imposed on the application server.

1. A communication management apparatus for managing contents of communication exchanged between a first communication apparatus and a second communication apparatus, comprising:
a communication information management control portion for extracting first communication information indicating contents of communication with the second communication apparatus from a message received from the first communication apparatus, and extracting second communication information indicating contents of communication with the first communication apparatus from a message received from the second communication apparatus;
a communication information storage portion for storing the communication information extracted by the communication information management control portion; and
a communication information verification portion for comparing the contents of the first and second communication information stored in the communication information storage portion.

2. A communication management apparatus according to claim 1, wherein the communication information verification portion performs a process for comparing the contents of the first and second communication information in accordance with a message which is received from the first or second communication apparatus to request comparison between the contents of the first and second communication information.

3. A communication management apparatus according to claim 2, wherein the communication information verification portion generates information for notifying the communication apparatus transmitting the comparison request message, of a result of the comparison.

4. A communication management apparatus according to claim 1, wherein communication between each communication apparatus and the communication management apparatus is performed in accordance with a session initiation protocol (SIP) and via an SIP server.

5. A communication management apparatus according to claim 4, wherein communication with the SIP server is encrypted.

6. A communication management apparatus according to claim 1, wherein the communication information verification portion performs a process for comparing the contents of the first and second communication information when a request to compare the contents of the first and second communication information is further contained in a message from the first or second communication apparatus.

7. A communication management apparatus according to claim 1, wherein:
the communication information storage portion stores the communication information between the communication apparatuses in accordance with every session; and
the communication information verification portion specifies the communication information to be compared, from the communication information storage portion by using identification information for identifying every session.

8. A communication management apparatus according to claim 7, wherein:
the identification information contains the IP address of each communication apparatus, and the port number used in the communication; and
the communication information in the communication information storage portion is specified on the basis of a combination of IP addresses and port numbers of terminals which communicate with each other.

9. A communication management apparatus according to claim 7, wherein:
the first or second communication information contains a start time of acquisition of the communication information, and an end time of acquisition of the communication information; and
the communication information verification portion compares two pieces of the communication information equal or close to each other in terms of the start time or end time.

10. A communication management system for managing contents of communication exchanged between a first communication apparatus and a second communication apparatus, comprising:
a first communication management apparatus for extracting and storing first communication information which is contained in a message received from the first communication apparatus and which expresses contents of communication with the second communication apparatus; and
a second communication management apparatus for extracting and storing second communication information which is contained in a message received from the second communication apparatus and which expresses contents of communication with the first communication apparatus, wherein the first communication management apparatus acquires the second communication information from the second communication apparatus to thereby compare the contents of the second communication information with the contents of the first communication information.

11. A communication management system according to claim 10, wherein:
the first communication management apparatus includes a communication management apparatus correspondence storage portion for storing correspondence between the second communication apparatus and the second communication management apparatus; and
when the first communication information is compared with the second communication information, the communication management apparatus correspondence storage portion is referred to so that a message to request the second communication information is sent to the second communication management apparatus.

12. A communication management system according to claim 10, wherein the first and second communication apparatuses store the communication information in accordance with communication set between the communication apparatuses and specify the communication information to be compared by using identification information for identifying communication of every communication apparatus.

13. A communication management system according to claim 12, wherein:
the identification information contains the IP address of each communication apparatus, and the port number used in the communication; and
the communication information in each communication management apparatus is specified on the basis of a combination of IP addresses and port numbers of terminals which communicate with each other.
